(19) United States
(12) Patent Application Publication
(10) Pub. No.: US 2024/0209232 A1
(43) Pub. Date: Jun. 27, 2024

(54) COATING COMPOSITIONS AND RELATED METHODS

(71) Applicant: AXALTA COATING SYSTEMS IP CO., LLC, Wilmington, DE (US)

(72) Inventors: Monika J. Sienkowska, Philadelphia, PA (US); Mei Wen, Chesterbrook, PA (US); Simcha E. Felder, Philadelphia, PA (US); Wiebke Becker, Essen (DE); Carl Brent Douglas, Garnet Valley, PA (US); Jeffery W. Johnson, Rochester, MI (US)

(73) Assignee: AXALTA COATING SYSTEMS IP CO., LLC, Wilmington, DE (US)

(21) Appl. No.: 18/542,212

(22) Filed: Dec. 15, 2023

Related U.S. Application Data
(60) Provisional application No. 63/387,810, filed on Dec. 16, 2022.

(51) Int. Cl. C09D 175/04; C08G 18/34; C08G 18/38; C08G 18/66; C08G 18/79

(52) U.S. Cl. CPC C09D 175/04; C08G 18/341; C08G 18/3821; C08G 18/6651; C08G 18/792

(57) ABSTRACT

A polyaspartate composition comprising an asymmetric polyaspartate resin is disclosed. The asymmetric polyaspartate resin is the reaction product of an asymmetric aspartate composition and an isocyanate chain extender. The asymmetric aspartate composition is a reaction product of a multi-functional acrylate component, at least one dialkyl butenedioate, and a multi-functional primary amino compound. A multi-resin form of the polyaspartate composition is also disclosed. The multi-resin polyaspartate composition includes at least two different variants of the asymmetric polyaspartate resin. A method of preparing the polyaspartate composition is also disclosed, along with a coating composition including the polyaspartate composition, a method of preparing a coated article therewith, and coated articles so prepared.

### CROSS-REFERENCE TO RELATED APPLICATIONS

This application claims the benefit of U.S. Provisional Application No. 63/387,810, filed Dec. 16, 2022, which is incorporated by reference herein in its entirety.

### FIELD OF THE DISCLOSURE

This disclosure relates generally to polyaspartate coating compositions and, more specifically, to asymmetric polyaspartate resin-based compositions, curable coatings, and coated articles, and methods of making and using the same.

### BACKGROUND

Performance coatings based on isocyanate chemistries are well known and widely used across myriad industries. In automotive manufacturing and maintenance, for example, polyurethane coatings are ubiquitous in primers, base coats, and clear coats in both original and repair vehicle coatings. Common components of such coatings (e.g. polyisocyanates, polyols, etc.) are readily available, and can be used to prepare coatings with good protection against abrasion, chemicals, corrosion, heat or mechanical impact.

Unfortunately, chemistries used for imparting performance coatings with uniquely beneficial properties for one application are typically associated with technical deficiencies, poor performance, and/or low productivity in other applications. For example, depending on particular applications, two-component coatings utilizing aspartic esters are widely used because of low viscosities, tolerance of high-solids levels, fast cure, and potentially good appearance. However, many curable aspartate compositions for preparing such coatings suffer from numerous drawbacks. For example, most aspartic esters that have the right potlife for automotive coatings have low functionality (functionality=2, i.e. two NH groups per molecule) and form coatings with low crosslink density, which would affect scratch resistance and durability of the coating. Addition of high-functionality polyol resins into a coating composition with aspartic esters and polyisocyanates significantly reduces potlife. Pigmented high-gloss polyaspartate coatings are known to suffer from appearance deficiencies such as gloss reduction in high temperature/high humidity conditions, and may exhibit haze and discoloration during normal lifespans of coated products. Conventional aspartate coatings formulated for improved scratch resistance are unfortunately also associated with poor appearance and low productivity. Accordingly, there remains an opportunity to develop improved coating chemistries to achieve a desired balance of properties such as potlife, appearance, productivity, adhesion, scratch resistance, and durability performance.

### BRIEF SUMMARY

A polyaspartate composition is provided. The polyaspartate composition includes an asymmetric polyaspartate resin, which is the reaction product of an asymmetric aspartate composition and an isocyanate chain extender. The asymmetric aspartate composition is a reaction product of a multi-functional acrylate component, which includes an average of at least two acrylate groups per molecule and is substantially free from mono-functional acrylate compounds, at least one dialkyl butenedioate, and a multi-functional primary amino compound.

A multi-resin form of the polyaspartate composition, or multi-polyaspartate composition, is also provided. The multi-polyaspartate composition includes at least two of the asymmetric polyaspartate resins, each independently being a reaction product of one form of the asymmetric aspartate composition and the isocyanate chain extender.

A method of preparing the polyaspartate composition is also provided. The method includes reacting the multi-functional acrylate component, the at least one dialkyl butenedioate, and the multi-functional primary amino compound to give the asymmetric aspartate composition, and reacting the asymmetric aspartate composition with the isocyanate chain extender to form the asymmetric polyaspartate resin and give the polyaspartate composition. In an implementation, the method includes preparing and then combining together at least two different variants of the asymmetric polyaspartate resin, thereby giving the multi-polyaspartate composition.

A coating composition comprising a curable polyaspartate component is also provided. The curable polyaspartate component comprises the polyaspartate composition or the multi-polyaspartate composition.

A method of preparing a coated article with the coating composition, and coated articles prepared by the method and/or using the coating composition are also provided.

### BRIEF DESCRIPTION OF THE DRAWINGS

FIG. 1 is a plot of Amtec scratch performance results of various single and multi-resin coating compositions prepared in the Examples, in accordance with the present embodiments.

FIG. 2 is a plot of Amtec scratch performance results of various additional single and multi-resin coating compositions prepared in the Examples, in accordance with the present embodiments.

FIG. 3 is a plot of Amtec scratch performance results of various single and multi-resin comparative coating compositions prepared in the Examples.

### DETAILED DESCRIPTION

The following detailed description is merely exemplary in nature and is not intended to limit the instant composition or method. Furthermore, there is no intention to be bound by any theory presented in the preceding background or the following detailed description. Conventional techniques related to the compositions, methods, processes, and portions thereof set forth in the embodiments herein may not be described in detail for the sake of brevity. Various tasks and process steps described herein may be incorporated into a more comprehensive procedure or process having additional steps or functionality not described in detail herein for being well-known and readily appreciated by those of skill in the art. As such, in the interest of brevity, such conventional steps may only be mentioned briefly or will be omitted entirely without providing well-known process details.

A polyaspartate composition comprising at least one asymmetric polyaspartate resin is provided. The asymmetric polyaspartate resin enables coating chemistries capable of improved performance, scratch resistance, without drawbacks or reduced performance metrics exhibited by conventional polyaspartate coatings such as appearance and productivity. As such, high-performance coating compositions based on the polyaspartate composition are also provided herein, along with methods of preparing the compositions, preparing a coating therefor, and preparing a coated article therewith. As demonstrated herein, coating compositions of the present embodiments may be formulated to exhibit a balanced drying performance in terms of fast curing times at sufficient long potlife, and give coatings with excellent mechanical properties including scratch resistance.

The asymmetric polyaspartate resin is an isocyanate chain-extended asymmetric aspartate composition, i.e., a reaction product of (I) an asymmetric aspartate composition and (II) an isocyanate chain extender. Accordingly, the asymmetric polyaspartate resin will be best understood in view of the constituent parts of the chain-extension reaction and, in turn, the components thereof.

The asymmetric aspartate composition (I) comprises, alternatively consists essentially of, alternatively is, a reaction product of three primary components: (A) a multi-functional acrylate component; (B) at least one dialkyl butenedioate; and (C) a multi-functional primary amino compound. These components are described in further detail below.

Component (A) comprises, alternatively is, a multi-functional acrylate compound. In this sense, the multi-functional acrylate component (A) generally comprises an average of at least two acrylate functional groups (e.g. acryloyloxy and/or methacryloyloxy groups) per molecule of acrylate compound. In this fashion, the multi-functional acrylate component (A) comprises, alternatively is, a multi-acrylate compound, which may also be described as a polyacrylic ester, polyacrylate, etc. The term “acrylate” is used regarding component (A) in general reference to reactive/reactable acrylate groups (i.e., the presence of acryloyloxy functional groups), and not to post-reacted acrylates. In this sense, the term multi-acrylate compound is preferred, although reference to a polyacrylic ester is to be likewise understood in view of the definition herein. Moreover, the term “acrylate” regarding functional groups encompasses both acryloyloxy and substituted acryloyloxy groups, such as methacryloyloxy groups, etc. The multi-functional acrylate component (A) may comprise the same or different types of such acrylate groups, as will be appreciated from the description herein.

Examples of suitable multi-acrylate compounds include difunctional acrylic esters, trifunctional acrylic esters, and higher functional acrylic esters suitable with the reaction chemistries set forth herein. Such compounds may be prepared or otherwise obtained for use in the present embodiments, with preparation procedures being readily known in the art and specific compounds being known and commercially available, as exemplified and described in further detail herein.

In some embodiments, the multi-functional acrylate component (A) comprises a difunctional acrylic ester (i.e., a diacrylate compound). Examples of such diacrylate compounds include ethyleneglycol di(meth)acrylate, propyleneglycol di(meth)acrylate, 1,4-butanediol di(meth)acrylate, 1,3-butanediol di(meth)acrylate, neopentyl glycol di(meth)acrylate, 1,6-hexanediol di(meth)acrylate, cyclohexanedimethanol di(meth)acrylate, 2-methyl-1,8-octanediol di(meth)acrylate, 1,10-decanediol di(meth)acrylate, diethylene glycol di(meth)acrylate, triethylene glycol di(meth)acrylate, tetraethylene glycol di(meth)acrylate, 1,3-butylene glycol di(meth)acrylate, tripropylene glycol di(meth)acrylate, tricyclodecane dimethanol diacrylate, and the like, as well as combinations and derivatives and/or variations thereof. It is to be understood that derivatives and/or variations of such diacrylate compounds, which are set forth in terms of methacryloyloxy substitution, include the acryloyloxy variants thereof. In particular, examples of the diacrylate compounds suitable for the multi-functional acrylate component (A) are to be understood in view of the preceding list to also include ethyleneglycol diacrylate, propyleneglycol diacrylate, 1,4-butanediol diacrylate, 1,6-hexanediol diacrylate, cyclohexanedimethanol diacrylate, etc., and combinations thereof, as well as combinations with the methacrylate variants above.

In some embodiments, the multi-functional acrylate component (A) comprises a trifunctional acrylic ester (i.e., a triacrylate compound). Examples of such triacrylate compounds include trimethylolpropane tri(meth)acrylate, trimethylolethane tri(meth)acrylate, glycerine tri(meth)acrylate, trimethylolpropane triacrylate, trimethylolethane triacrylate, glycerine triacrylate, and the like, as well as combinations and derivatives and/or variations thereof.

Additional examples of multi-acrylate compounds suitable for use in or as the multi-functional acrylate component (A) include tetra-acrylates such as pentaerythritol tetra(meth)acrylate, penta-acrylates, hexa-acrylates such as dipentaerythritol hexa(meth)acrylate, and the like, as well as combinations and derivatives and/or variations thereof.

In some embodiments, the multi-functional acrylate component (A) comprises, alternatively consists essentially of, alternatively is at least one of a difunctional acrylic ester and a trifunctional acrylic ester. In some such embodiments, the difunctional acrylic ester selected from linear alkyldiol diacrylates, such as 1,6-hexanediol diacrylate (HDDA), 1,4-butanediol diacrylate (BDDA). In these or other such embodiments, the trifunctional acrylic ester is selected from trimethylolpropane triacrylate (TMPTA), trimethylolpropane ethoxy triacrylate (TMPEOTA).

In specific embodiments, the multi-functional acrylate component (A) comprises trimethylolpropane triacrylate (TMPTA), trimethylolpropane ethoxy triacrylate (TMPEOTA), 1,6-hexanediol diacrylate (HDDA), 1,4-butanediol diacrylate (BDDA), or a combination thereof. In particular embodiments, the multi-functional acrylate component (A) is trimethylolpropane triacrylate (TMPTA). In other particular embodiments, the multi-functional acrylate component (A) is 1,6-hexanediol diacrylate (HDDA).

In general, the multi-functional acrylate component comprises an average of at least two acrylate groups per molecule. However, the multi-functional acrylate component (A) may comprise any number of multi-functional acrylate compounds, such that an average higher than 2, alternatively higher than 2.5 acryloyloxy functional groups per molecule in component (A) may be utilized. It is also to be appreciated that the multi-functional acrylate component (A) may comprise, alternatively may be, an acrylate-functional polymer or oligomer, such as a methacrylate-caped urethane oligomer, etc.

Typically, component (A) is substantially free from mono-functional acrylate compounds. That is, in certain embodiments, component (A) does not include acrylate components that have but one acryloyloxy group, such as methyl (meth)acrylate, ethyl (meth)acrylate, propyl (meth)acrylate, butyl (meth)acrylate, isobornyl (meth)acrylate, etc. In the same fashion, the asymmetric aspartate composition (I) is typically prepared without inclusion or presence of mono-functional acrylates in the reaction mixture of (A)-(C). However, as will be appreciated from the description of the multi-polyaspartate resin composition below, in certain embodiments the asymmetric aspartate composition (I) thus prepared may be combined with one or more additional asymmetric aspartate compositions that are not free from mono-functional acrylates.

Component (B) comprises at least one dialkyl butenedioate. Dialkyl butenedioates may be synonymously described as dialkyl maleates and dialkyl fumarates, both types of which may be utilised in or as component (B). Typically, dialkyl maleates are selected, as described in additional detail below.

In general, dialkyl butenedioates have the formula R¹O(O)CCH═CHC(O)OR², where each of R¹ and R² is an independently selected alkyl group. Examples of alkyl groups include methyl, ethyl, propyl (e.g. iso-propyl and/or n-propyl), butyl (e.g. isobutyl, n-butyl, tert-butyl, and/or sec-butyl), pentyl (e.g. isopentyl, neopentyl, and/or tert-pentyl), hexyl, heptyl, octyl (e.g. n-octyl, 2-ethylhexyl, etc.), lauryl, and the like, as well as combinations and derivatives and/or variations thereof. Such derivatives and/or variations thereof will be understood to include other linear, branched, and/or cyclic hydrocarbon groups, including isomers of those above, those having greater than 6 carbon atoms, cyclic forms of those above, etc. For example, cycloalkyl groups such as cyclohexyl, di-tert-butylcyclohexyl, etc. are also included.

Examples of specific dialkyl butenedioates include dialkyl maleates, such as dimethyl maleate, diethyl maleate, dibutyl maleates, diamyl maleates, dioctyl maleates, dilauryl maleates, dicycloalkyl maleates (e.g. dicyclohexyl maleates, di-tert-butylcyclohexyl maleates, etc.), and the like, as well as combinations and derivatives and/or variations thereof (e.g. di-n-butyl maleate, di-iso-butyl maleate, di-tert-butyl maleate, etc.). It will be appreciated that such compounds may be referred to and/or described in different ways without departing the scope of the present embodiments. For example, the compound bis(2-ethylhexyl) maleate is conventionally known as dioctyl maleate (DOM), and illustrates the variations on the dialkyl maleates suitable for use herein. Examples of specific dialkyl butenedioates also include dialkyl fumarates, which include the fumarate version of any of the maleates above (e.g. dimethyl fumarate, diethyl fumarate, dioctyl fumarate, diamyl fumarate, dilauryl fumarate, etc.), dicyclohexyl fumarate, etc.

Typically, component (B) comprises, alternatively is, a dialkyl maleate. However, it is to be appreciated that such dialkyl maleates may isomerize under normal conditions (e.g. before and/or during use) such that any practical choice selected for use in or as component (B) may comprise a mixture of maleate and fumarate isomers of the same dialkyl butenedioate compound.

Component (B) may comprise but one, or more than one, of the dialkyl butenedioates. In some specific embodiments, component (B) consists essentially of but one dialkyl butenedioate. In general embodiments, however, component (B) may comprise at least one, at least two, at least three, or at least four dialkyl butenedioates. In specific embodiments, component (B) comprises at least two dialkyl butenedioates. Where more than one of the dialkyl butenedioates are used, dialkyl maleates, dialkyl fumarates, or combination thereof may be employed in or as component (B).

In some embodiments, component (B) comprises at least one of dibutyl maleate (DBM), dioctyl maleate (DOM), and a combination thereof.

In particular embodiments, component (B) comprises at least two different dialkyl maleates. In some such embodiments, at least one of the dialkyl maleates is selected from diethyl maleate (DEM), dibutyl maleate (DBM), and dioctyl maleate (DOM). In specific such embodiments, each of the different dialkyl maleates is selected from diethyl maleate (DEM), dibutyl maleate (DBM), and dioctyl maleate (DOM).

It is to be appreciated that more than two dialkyl maleates may also be utilized in or as component (B), such that the specific examples above are not all-inclusive. Rather, the examples included herein are illustrative of dialkyl maleates that may be used in terms of different molecular properties (e.g. chain lengths, hydrophobicity/hydrophilicity, solubility, etc.) and performance properties of the resulting resins (e.g. Tag, Mw, etc.). As such, different combinations and ratios of dialkyl maleates may be utilized in component (B) to achieve the same or different results as other combinations and/or ratios, as will be readily understood by those of skill in the art.

Component (C) comprises, alternatively is, a multi-functional primary amino compound. In typical embodiments, the multi-functional primary amino compound (C) is an organodiamine having two primary amine groups. However, other polyamino compounds, such as organotriamines, polyaminosiloxanes, etc., may also be utilized. Likewise, mixtures of multi-functional primary amino compounds may be used in or as component (C).

Suitable multi-functional primary amino compounds include generally include two or more primary amino groups (i.e., —NH₂). In some embodiments, the multi-functional primary amino compound is selected from organodiamines. Examples of such organodiamines include aliphatic diamines such as ethylene diamine, 1,2-diaminopropane, 1,4-diaminobutane, 1,3-diaminopentane, 1,6-diaminohexane, 2,5-diamino-2,5-dimethylhexane, 2,2,4- and 2,4,4-trimethyl-1,6-diaminohexane, 1,11-diaminoundecane, 1,12-diaminododecane, diethylenetriamine, triethylenetetramine, 2-methyl-1,5-pentanediamine, 2-[2-(2-aminoethoxy)ethoxy]ethylamine, 3-[2-(3-aminopropoxy) ethoxy]propylamine, 3-[3-(3-amino-propoxy)propoxy]propylamine, 3-[4-(3-amino-propoxy)butoxy]propylamine, 3-{2-[2-(3-aminopropoxy)ethoxy]ethoxy}propylamine and cycloaliphatic, such as mono- or bicycloaliphatic, and/or arylalkyl diamines such as 1,3- and 1,4-cyclohexane diamine, 5-amino-1,3,3-trimethyl-cyclohexanemethanamine (i.e., “isophoronediamine”, (IPDA)), norbornyldiamine, 2,4- and 2,6-hexahydrotoluylene diamine, 2,4′- and 4,4′-diamino-dicyclohexyl methane and 3,3′-dialkyl-4, 4′-diaminodicyclohexylmethanes, 3, 3′-dimethyl-4, 4′-diaminodicyclohexyl methane and 3,3′-diethyl-4,4′-diaminodicyclohexylmethane, 1,3- and 1,4 xylylenediamine, tetramethyl xylylenediamine, and combinations thereof.

In some embodiments, the multi-functional primary amino compound is a cycloaliphatic diamine, such as a mono- or bicycloaliphatic diamine. Examples of these include isophoronediamine (i.e., 1-amino-3,3,5-trimethyl-5-aminomethylcyclohexane (IPDA)), norbornyldiamine, 2,4′- and 4,4′-diaminodicyclohexyl methane (PACM) and 3,3′-dialkyl-4, 4′-diaminodicyclohexylmethanes, such as 3, 3′-dimethyl-4, 4′-diaminodicyclohexyl methane and 3,3′-diethyl-4,4′-diaminodicyclohexylmethan and mixtures thereof.

In some embodiments, the multi-functional primary amino compound is polyetherdiamine of the following formula:

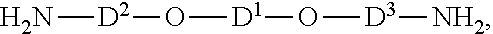

wherein D¹, D², and D³ independently represent hydrocarbyl linking groups having from 2 to 15, alternatively from 2 to 8, alternatively from 2 to 6, alternatively from 2 to 4 carbon atoms. Examples of such compounds include 2-[2-(2-aminoethoxy)ethoxy]ethylamine (e.g. Jeffamine XTJ-504, available from Huntsman), 3-[2-(3-aminopropoxy) ethoxy]propylamine (e.g. Etheramine NDPA 10, available Tomah from Products), 3-[3-(3-amino-propoxy)propoxy]propylamine (e.g. Etheramine NDPA 11, available from Tomah Products), 3-[4-(3-amino-propoxy)butoxy]propylamine (e.g. Etheramine NDPA 12, available from Tomah Products) and 3-{2-[2-(3-aminopropoxy)ethoxy]ethoxy}propylamine (e.g. Etheramine DPA-DEG, available from Tomah Products or BASF TTD, available from BASF).

In specific embodiments, the multi-functional primary amino compound (C) is isophoronediamine (IPDA). In some such embodiments component (C) consists essentially of, alternatively is, isophoronediamine (IPDA).

In certain embodiments, the multi-functional acrylate component (A) comprises trimethylolpropane triacrylate (TMPTA), trimethylolpropane ethoxy triacrylate (TMPEOTA), 1,6-hexanediol diacrylate (HDDA), butanediol diacrylate (BDDA), or a combination thereof; the at least one dialkyl butenedioate (B) comprises a dibutyl maleate (DBM), a dioctyl maleate (DOM), or a combination thereof; and/or the asymmetric multi-functional primary amino compound (C) comprises isophoronediamine (IPDA). In some such embodiments, the at least one dialkyl butenedioate (B) further comprises a diethyl maleate (DEM).

It is to be appreciated that particular selections of components (A)-(C) may be made by one of skill in the art, informed by the present embodiments, to achieve improved performance and/or properties of the resulting resins and coatings prepared therewith, including increased crosslinked density, increased flexibility, and improved scratch resistance

The mixture of (A)-(C) from which the reaction product of the asymmetric aspartate composition (I) is obtained will be selected in view of the desired use and end properties of the aspartate compositions, resin, and coatings desired. As such, the proportion of (A):(B) may be varied widely. For example, the multi-functional acrylate component (A) and the at least one dialkyl butenedioate (B) may be reacted to form the asymmetric aspartate composition (I) in a stoichiometric ratio of from about 0.1:99.9 to about 50:50 (A):(B). It will be understood that such a stoichiometric ratio will be based on the reactive functional groups involved in the preparation of the aspartate composition (I), e.g. the acrylate groups of component (A), the double bonds in component (B), the reactive amine groups in component (C), etc.

With regard to the proportions of (A):(B), in typical embodiments the components will be reacted in a ratio of from about 5:95 to about 50:50 (A):(B), such as from about 5:95 to about 30:70, alternatively of from about 10:90 to about 30:70, alternatively of from about 10:90 to about 25:75 (A):(B). Depending on the exact conditions employed, the ratio (A):(B) may be selected outside of these ranges as well. However, those of skill in the art will understand that the amount of component (A) may, above a certain limit, lead to increased gelling and thus be detrimental to the reaction.

The proportion of (C) is typically selected based on the combined amounts and functionality (i.e., the total functional equivalents) of (A) and (B). For example, the -multi-functional primary amino compound (C) may be reacted together to form the asymmetric aspartate composition (I) by using a stoichiometric ratio of from about 0.95:1 to about 1.5:1 (C):(A)(B). In this case, the ratio (C):(A)(B), represents the number of reactive primary amine groups —NH₂ of component (C) to the combined number of reactive functional groups of components (A) and (B) (i.e., reactive acrylate groups+reactive enoate groups). As such, it will be appreciated that a single stoichiometric equivalent of component (C) may be utilized (i.e., a 1:1 ratio (C):(A)(B)), alternatively a slight excess of components (A) and/or (B) may be utilized (e.g. a 0.95:1 ratio (C):(A)(B)), or alternatively an excess of component (C) may be utilized (e.g. a 1.5:1 ratio (C):(A)(B)). One of skill in the art will select the particular proportions based on the desired functionality of the asymmetric aspartate composition (I).

In general, a 1:1 ratio (C):(A)(B) is targeted to minimize the free reactive groups from all three components remaining in the asymmetric aspartate composition (I). In specific embodiments, the amount of component (C) is selected to give a stoichiometric ratio of the components of from about 0.95:1 to about 1.4:1, alternatively from about 0.98:1 to about 1.3:1; alternatively from about 0.99:1 to about 1.25:1, alternatively from about 1:1 to about 1.2:1 (C):(A)(B).

For the stoichiometric ratios above, it will be readily understood by those of skill in the art that molar ratios may also be used to inform the particular proportions of components (A)-(C) utilized, as they relate to the stoichiometric ratios by nature of the molar amount of component utilized multiplied by the number of functional groups present. Such amounts (e.g. loading amounts, by mass) are illustrated with particularity by the embodiments demonstrated in the examples below.

As introduced above, the asymmetric polyaspartate resin is a reaction product of the asymmetric aspartate composition (I) and the isocyanate chain extender (II). In this fashion, it will be understood that the reaction product of (A)-(C) in the asymmetric aspartate composition (I) is isocyanate-reactive, specifically, via N—H functionality imparted by component (C). Accordingly, the isocyanate chain extender (II) is not particularly limited, and may be selected from any isocyanates (e.g. multi-isocyanate functional group-containing compounds) capable of chain-extending the aspartate reaction product of (A)-(C) to give the asymmetric polyaspartate resin.

The isocyanate chain extender (II) can be or include any kind of organic multi-isocyanate compound, i.e., an organic compound with two or more aliphatically, cycloaliphatically, araliphatically and/or aromatically-bound free isocyanate groups. It will be understood that the isocyanate chain extender (II) may, in some instances, be referred to as a “polyisocyanate” due to the presence of at least two free isocyanate groups. However, in the context of the present disclosure, the term “polyisocyanate” is used with reference to di-, tri-, or other oligomeric forms of isocyanate compounds, whereas the terms “multi-isocyanate compound” and “multi-functional isocyanate” are used herein to refer to compounds based on number of free isocyanate groups (i.e., regardless of whether such multi-isocyanate compounds can be used in dimeric, trimeric, or other oligomeric forms). The specific types and classes of multi-isocyanate compounds suitable for use in or as the isocyanate chain extender (II) will be readily apparent to those of skill in the art in view of the description and examples herein. In some embodiments, the isocyanate chain extender (II) is liquid at room temperature, or becomes liquid through the addition of an organic solvent compatible with the reaction of (I) and (II).

In some embodiments, the isocyanate chain extender (II) has an average NCO functionality from 1.5 to 6.0, alternatively 1.8 to 4.0, alternatively of about 2.0.

In some embodiments, the isocyanate chain extender (II) may be selected from 1-isocyanato-3,3,5-trimethyl-5-isocyanatomethyl-cyclohexane (IPDI), 1,5-pentane diisocyanate, 4,4′-diisocyanatocyclohexylmethane, cyclotrimers, urethdione dimers and/or biurets of 1-isocyanato-3,3,5-trimethyl-5-isocyanatomethyl-cyclohexane, hexamethylene diisocyanate (HDI), and their derivatives, 1,1′,6,6′-tetramethyl-hexamethylene diisocyanate, p- or m-tetramethylxylylene diisocyanate, 2,2′,5 trimethylhexane diisocyanate, aromatic multi-isocyanates such as toluene diisocyanate, diphenylmethane diisocyanate; and combinations thereof.

Typically, the isocyanate chain extender (II) comprises, alternatively is, an alkyl diisocyanate, an aryl diisocyanate, an alkaryl diisocyanate, or a combination thereof. In specific embodiments, for example, the isocyanate chain extender (II) is selected from isophorone diisocyanate (IPDI), 1,5-pentane diisocyanate (PDI), 4,4′-diisocyanato dicyclohexylmethane (HMDI), hexamethylene diisocyanate (HDI), tetramethylxylylene diisocyanate (TMXDI), trimethylhexamethylene diisocyanate (TMDI), toluene diisocyanate (TDI), and combinations thereof. In specific embodiments, the isocyanate chain extender (II) is isophorone diisocyanate (IPDI).

In order to obtain the asymmetric polyaspartate resin with well-balanced drying performance, mechanical properties, and optical properties, it is typically desirable to prepare the asymmetric polyaspartate resin free of isocyanate groups. Additionally, it may be desirable to prepare the asymmetric polyaspartate resin with a NH equivalent weight of from about 300 to about 5,000 g, alternatively from about 500 to about 2,500 g. As such, the asymmetric aspartate composition (I) is typically reacted (i.e., chain-extended) with the isocyanate chain extender (II) in a stoichiometric ratio of from about 0.05:1 to about 0.9:1 (II):(C), where such stoichiometric ratio is defined by the reactive functional groups involved in the chain extension, i.e., the ratio of the number of NCO groups of the isocyanate chain extender (II) to the number of reactive primary or secondary amine (NH) groups of the multi-functional primary amino compound (C), in the mixture of (A)-(C) from which the reaction product of the asymmetric aspartate composition (I) is obtained. For example, in some embodiments, the asymmetric polyaspartate resin is formed via chain extending the asymmetric aspartate composition (I) with the isocyanate chain extender (II) in a stoichiometric ratio of from about 0.1:1 to about 0.9:1, alternatively from about 0.1:1 to about 0.75:1, alternatively from about 0.1:1 to about 0.5:1, alternatively from about 0.2:1 to about 0.4:1 (II):(C). In some such embodiments, the asymmetric polyaspartate resin is prepared substantially free from free/unreacted isocyanate groups. In these or other embodiments, the asymmetric polyaspartate resin comprises an amine number of from about 50 to about 100, such as from about 55 to about 90, alternatively from about 60 to about 90, alternatively from about 60 to about 80.

The present embodiments provide for a multi-polyaspartate resin composition in accordance with the preceding description. Namely, the polyaspartate composition may comprise two or more of the asymmetric polyaspartate resin prepared according to the preceding embodiments. In specific embodiments, the multi-polyaspartate resin composition comprises a first asymmetric polyaspartate resin (1) and a second asymmetric polyaspartate resin (2) different from the first asymmetric polyaspartate resin (1). In such embodiments, the first asymmetric polyaspartate resin is a reaction product of (I-1) an asymmetric aspartate composition and (II-1) an isocyanate chain extender, where the asymmetric aspartate composition (I-1) comprises a reaction product of a mixture of: (A1) a multi-functional acrylate component comprising an average of at least two acrylate groups per molecule, (B1) at least one dialkyl butenedioate, and (C1) an asymmetric multi-functional primary amino compound. The second asymmetric polyaspartate resin is a reaction product of (I-2) an asymmetric aspartate composition and (II-2) an isocyanate chain extender, where the asymmetric aspartate composition (I-2) comprises a reaction product of a mixture of: (A2) a multi-functional acrylate component comprising an average of at least two acrylate groups per molecule, (B2) at least one dialkyl butenedioate, and (C2) an asymmetric multi-functional primary amino compound.

In such embodiments, each of components (A1) and (A2) is independently selected according to the parameters of component (A) above. Likewise, each of components (B1) and (B2) is independently selected according to the parameters of component (B) above, each of components (C1) and (C2) is independently selected according to the parameters of component (C) above. In the same fashion, the isocyanate chain extenders (II-1) and (II-2) are selected according to the parameters of the isocyanate chain extender (II) above.

In certain embodiments, the multi-functional acrylate component (A1) and the multi-functional acrylate component (A2) each independently comprise difunctional acrylic esters, trifunctional acrylic esters, or combinations thereof. In general, at least one of the multi-functional acrylate component (A1) and the multi-functional acrylate component (A2) is substantially free from mono-functional acrylate compounds, as described in further detail below. In some embodiments, both of the multi-functional acrylate component (A1) and the multi-functional acrylate component (A2) are substantially free from mono-functional acrylate compounds.

In some embodiments, the at least one dialkyl butenedioate (B1) and the at least one dialkyl butenedioate (B2) are each independently selected from dialkyl maleates. In these or other embodiments, the asymmetric multi-functional primary amino compound (C1) and the asymmetric multi-functional primary amino compound (C2) are each independently selected from organodiamines having two primary amine groups. In these or other embodiments, the isocyanate chain extender (II-1) and the isocyanate chain extender (II-2) are each independently selected from alkyl diisocyanates, aryl diisocyanates, alkaryl diisocyanates, and combinations thereof.

In some embodiments, the multi-polyaspartate composition is obtained as above, where the multi-functional acrylate component (A1) and the multi-functional acrylate component (A2) are each independently selected from trimethylolpropane triacrylate (TMPTA), trimethylolpropane ethoxy triacrylate (TMPEOTA), 1,6-hexanediol diacrylate (HDDA), butanediol diacrylate (BDDA), and combinations thereof; the at least one dialkyl butenedioate (B1) and the at least one dialkyl butenedioate (B2) are each independently selected from di(C₁-C10)alkyl maleates (i.e., dialkyl esters of maleate, where each alkyl group has from 1 to 10 carbon atoms); the at least one of the asymmetric multi-functional primary amino compound (C1) and the asymmetric multi-functional primary amino compound (C2) comprises isophoronediamine (IPDA); and/or the isocyanate chain extender (II-1) and the isocyanate chain extender (II-2) are each independently selected from isophorone diisocyanate (IPDI), 1,5-pentane diisocyanate (PDI), 4,4′-diisocyanato dicyclohexylmethane (HMDI), hexamethylene diisocyanate (HDI), tetramethylxylylene diisocyanate (TMXDI), trimethylhexamethylene diisocyanate (TMDI), toluene diisocyanate (TDI), and combinations thereof.

The first asymmetric polyaspartate resin (1) and the second asymmetric polyaspartate resin (2) are independently selected to be different from each other, and yet compatible in the polyaspartate composition. For example, in certain embodiments, one of the multi-functional acrylate component (A1) and the multi-functional acrylate component (A2) comprises a trifunctional acrylic ester selected from trimethylolpropane triacrylate (TMPTA), trimethylolpropane ethoxy triacrylate (TMPEOTA), and combinations thereof, and the other of the multi-functional acrylate component (A1) and the multi-functional acrylate component (A2) comprises a difunctional acrylic ester selected from linear alkyldiol diacrylates, alternatively from 1,6-hexanediol diacrylate (HDDA), butanediol diacrylate (BDDA), and combinations thereof. In this fashion, the functionality of the asymmetric polyaspartate resins differs, providing the polyaspartate composition with unique properties over either of the resins alone. In other such embodiments, at least two trifunctional acrylic esters or at least two difunctional acrylic esters are utilized as components (A1) and (A2), respectively. For example, in some embodiments the multi-functional acrylate component (A1) and the multi-functional acrylate component (A2) each comprises a trifunctional acrylic ester selected from trimethylolpropane triacrylate (TMPTA), trimethylolpropane ethoxy triacrylate (TMPEOTA), or combinations thereof. In other embodiments, each of the multi-functional acrylate component (A1) and the multi-functional acrylate component (A2) independently comprises a difunctional acrylic ester selected from linear alkyldiol diacrylates, alternatively from 1,6-hexanediol diacrylate (HDDA), butanediol diacrylate (BDDA), and combinations thereof.

In some embodiments, the multi-polyaspartate composition is obtained as above, where the one of the multi-functional acrylate component (A1) and the multi-functional acrylate component (A2) comprises a trifunctional acrylic ester selected from trimethylolpropane triacrylate (TMPTA), trimethylolpropane ethoxy triacrylate (TMPEOTA), and combinations thereof, and the other of the multi-functional acrylate component (A1) and the multi-functional acrylate component (A2) comprises a difunctional acrylic ester selected from linear alkyldiol diacrylates, alternatively from 1,6-hexanediol diacrylate (HDDA), butanediol diacrylate (BDDA), and combinations thereof; where the at least one dialkyl butenedioate (B1) and the at least one dialkyl butenedioate (B-2) each independently comprises a dibutyl maleate (DBM), a dioctyl maleate (DOM), a diethyl maleate (DEM), or a combination thereof; where the asymmetric multi-functional primary amino compound (C1) and the asymmetric multi-functional primary amino compound (C2) each independently comprises isophoronediamine (IPDA); and where the isocyanate chain extender (II-1) and the isocyanate chain extender (II-2) each independently comprises isophorone diisocyanate (IPDI).

In some embodiments, the multi-polyaspartate composition is obtained as above, where one of the multi-functional acrylate component (A1) and the multi-functional acrylate component (A2) is trimethylolpropane triacrylate (TMPTA), and the other of the multi-functional acrylate component (A1) and the multi-functional acrylate component (A2) is 1,6-hexanediol diacrylate (HDDA); where each of the at least one dialkyl butenedioate (B1) and the at least one dialkyl butenedioate (B2) comprises a dibutyl maleate (DBM), a dioctyl maleate (DOM), a diethyl maleate (DEM), or a combination thereof; wherein each of the asymmetric multi-functional primary amino compound (C1) and the asymmetric multi-functional primary amino compound (C2) is isophoronediamine (IPDA); and each of the isocyanate chain extender (II-1) and the isocyanate chain extender (II-2) is isophorone diisocyanate (IPDI).

The multi-polyaspartate composition, and components thereof, is generally as prepared above with regard to the polyaspartate composition. For example, in some embodiments, the mixture of (A1)-(C1) from which the reaction product of the asymmetric aspartate composition (I-1) is obtained comprises the multi-functional acrylate component (A1) and the at least one dialkyl butenedioate (B1) present in a stoichiometric ratio of from about 0.1:99.9 to about 50:50 (A1):(B1), alternatively of from about 5:95 to about 50:50 (A1):(B1), such as from about 5:95 to about 30:70, alternatively of from about 10:90 to about 30:70, alternatively of from about 10:90 to about 25:75 (A1):(B1); and the asymmetric multi-functional primary amino compound (C1) present in a stoichiometric ratio of from about 0.95:1 to about 1.5:1 (C1):(A1)(B1), such as from about 0.95:1 to about 1.4:1, alternatively from about 0.98:1 to about 1.3:1; alternatively from about 0.99:1 to about 1.25:1, alternatively from about 1:1 to about 1.2:1 (C1):(A1)(B1). In these or other embodiments, the mixture of (A2)-(C2) from which the reaction product of the asymmetric aspartate composition (I-2) is obtained comprises the multi-functional acrylate component (A2) and the at least one dialkyl butenedioate (B2) present in a stoichiometric ratio of from about 0.1:99.9 to about 50:50, alternatively of from about 5:95 to about 50:50 (A2):(B2), such as from about 5:95 to about 30:70, alternatively of from about 10:90 to about 30:70, alternatively of from about 10:90 to about 25:75 (A2):(B2); and the asymmetric multi-functional primary amino compound (C2) present in a stoichiometric ratio of from about 0.95:1 to about 1.5:1 (C2):(A2)(B2), such as from about 0.95:1 to about 1.4:1, alternatively from about 0.98:1 to about 1.3:1; alternatively from about 0.99:1 to about 1.25:1, alternatively from about 1:1 to about 1.2:1 (C2):(A2)(B2).

It is to be appreciated that the multi-polyaspartate composition of the present embodiments may comprise but one of the asymmetric polyaspartate resins prepared from components (A)-(C) above, and also at least one polyaspartate resin that is not so limited in selection. For example, while the single-resin compositions described herein are prepared from a component (A) that is substantially free from mono-functional acrylate compounds, the multi-polyaspartate composition may comprise such a resin prepared without mono-functional acrylate compounds, (i.e., from the asymmetric aspartate composition (I)) in combination with a second asymmetric aspartate composition, alternatively a third and/or fourth asymmetric aspartate composition, comprising an asymmetric polyaspartate resin being a reaction product of components (A)-(C) and also a mono-functional acrylate compound (e.g. methyl acrylate). Such mono-functional acrylate compounds, exemplified by nature of comprising but one acrylate functional group, are known in the art, and not limited with regard to such a second, third, fourth, etc. asymmetric polyaspartate resin of the multi-polyaspartate compositions. However, it will be appreciated that in all embodiments of the multi-polyaspartate composition, at least one, alternatively a combination of at least two, of the mono-acrylate-free asymmetric polyaspartate resins described herein is present.

The polyaspartate composition, and likewise the multi-polyaspartate composition, described herein are useful in, or as, a curable polyaspartate component of a coating composition. As such, a coating composition comprising a curable polyaspartate component is further provided herein, where the curable polyaspartate component comprises a polyaspartate composition according to the preceding embodiments. In some embodiments, the curable polyaspartate component comprises the multi-polyaspartate composition according to the preceding embodiments and, therefore, comprises two different variants of the asymmetric polyaspartate resins.

The coating composition is typically a liquid coating composition, including a liquid carrier. In some embodiments, the coating composition is substantially free from water and utilized an organic carrier. Organic solvent-based coating compositions are coating compositions, wherein organic solvents are used as solvents or thinners when preparing and/or applying the coating composition. Usually, solvent-based coating compositions contain, for example, 20 to 90% by weight of organic solvents, based on the total amount of the coating composition.

The organic solvents are solvents conventionally used in coating techniques. These may originate from the preparation of the binders or are added separately. Examples of suitable solvents are typically aprotic solvents, such as ethers, ketones, esters, etc. Specific examples include polar and nonpolar aprotic solvents, such as glycol ethers or esters, N-alkyl pyrrolidones (e.g. N-methyl pyrrolidone and N-ethyl pyrrolidone), ketones (e.g. methyl ethyl ketone, acetone, methyl isobutyl ketone, cyclohexanone), aromatic or aliphatic hydrocarbons (e.g. toluene, xylene, straight-chain or branched aliphatic C6-C12-hydrocarbons, aliphatic hydrocarbons like hexane, heptane, and dodecane), mineral spirits, esters (e.g. methyl-, ethyl-, propyl-, iso-propyl-, n-butyl-, iso-butyl-, tert-butyl-, and hexyl-acetates, propionates and/or butyrates), ethers (e.g. tetrahydrofuran, methylal, ethylal, butylal, diethylether, dibutylether, etc.), ether-ester solvents (e.g. ethyleneglycol monobutylether acetate, monoethylether acetate), and the like, as well as combinations thereof. Exemplary solvents are esters such as methyl-, ethyl-, propyl-, isopropyl-, n-butyl-, iso-butyl-, tert-butyl-, and hexyl-esters of acetates, propionates, and/or butyrates, and ether-esters such as ethyleneglycol monobutylether acetate, monoethylether acetate, and the like. In typical embodiments, n-butyl acetate is used as the solvent/organic carrier. It is to be appreciated that a solventless coating system may also be employed. Likewise, the coating composition may be free from a particular solvent, e.g. on the basis of environmental and/or regulatory concerns.

Typically, the coating composition comprises a curing agent, as detailed below. The coating composition can be in the form of a one-component coating composition or two-component coating composition. To prevent premature curing and allow processing, the composition may be in the form of a two-part curable composition, having a first part (Part A) comprising the polyaspartate component and a second part (Part B) comprising the curing agent. In other words, the components which are reactive towards one another, namely the polyaspartate component and the curing agent, must be stored separately from one another prior to application in order to avoid a premature reaction. Generally, the polyaspartate component and the curing agent may only be mixed together shortly before application. The term “shortly before application” is well-known to a person skilled in the art. The time period within which the ready-to-use coating composition may be prepared prior to the actual use/application depends, e.g., on the potlife of the coating composition. Compositions with very short potlife may be applied by two-component spray guns, where the reactive components are separately fed into a static mixer and applied directly afterwards.

In some embodiments, the polyaspartate component and the curing agent are formulated together in one composition.

Typically, the curing agent is an isocyanate curing agent, i.e., a curing agent with free and reactive isocyanate groups. Alternatively, the curing agent may comprise two or more kinds of curing agents, typically with at least one having free and reactive isocyanate groups. The isocyanate curing agent can be a polyisocyanate or polyisocyanate mixture, e.g. with exclusively aliphatically and/or cycloaliphatically bound isocyanate groups, such as those with an average NCO functionality of 1.5 to 6.0, alternatively from 1.8 to 4.0. General and specific examples of suitable curing agents, including isocyanate and polyisocyanate curing agents, are set forth in U.S. Pat. No. 10,519,336, which is incorporated by reference herein.

Examples of suitable isocyanate curing agents include polyisocyanate forms of the isocyanate compounds set forth above with respect to the isocyanate chain extender (II). As such, it will be appreciated that in some embodiments the same isocyanate compounds may be present or otherwise used in or as the isocyanate chain extender (II) and the curing agent. In some embodiments, however, the isocyanate chain extender (II) is selected from non-oligomeric isocyanates, whereas the isocyanate curing agent in the same embodiments is selected from oligomeric isocyanates (e.g. converted trimeric forms of the same isocyanate as used for the isocyanate chain extender (II)).

As will be understood by those of skill in the art, diisocyanates can be converted by usual processes to higher functional compounds, for example, by trimerization or by reaction with water or polyols, such as, for example, trimethylolpropane or glycerine. Thus, the at least one curing agent having free isocyanate groups can also be used in the form of a reaction product such as an isocyanate-modified resin or isocyanate-functional pre-polymers. Such curing agents may be selected from isophorone diisocyanate (IPDI), 1,5-pentane diisocyanate (PDI), methylene diphenyl diisocyanate (MDI), 4,4′-methylenebis(cyclohexyl isocyanate) (HMDI), hexamethylene diisocyanate (HDI), tetramethylxylylene diisocyanate (TMXDI), trimethylhexamethylene diisocyanate (TMDI), toluene diisocyanate (TDI), combinations thereof, and polyol-modified derivatives thereof.

Generally, the isocyanate curing agent can include, or be selected from, isocyanurates, uretdione diisocyanates, biuret group-containing polyisocyanates, urethane group-containing polyisocyanates, allophanate group-containing polyisocyanates, polyester and polyether containing polyisocyanates, polyacrylic containing polyisocyanates, carbodiimide group containing polyisocyanates, and polyisocyanates containing acylurea groups. Moreover, the isocyanate groups of the curing agent may be completely or partially blocked. Low molecular weight compounds containing active hydrogen for blocking NCO groups are known in the art, aliphatic or cycloaliphatic alcohols, dialkylamino alcohols, oximes, lactams, imides, hydroxyalkyl esters and esters, and N-containing 5 and 6 membered heterocyclics such as imidazoles and pyrazoles of malonic or acetoacetic acid.

The coating composition typically comprises the curable polyaspartate component and the polyisocyanate curing agent in a stoichiometric ratio of from about 0.8 to about 2, alternatively of from about 0.9 to about 2, alternatively from about 1 to about 1.5, alternatively from about 1.1 to about 1.5 NCO:NH, based on the total number of free isocyanate groups (NCO) in the polyisocyanate curing agent and the total number of free amine groups (NH) in the multi-polyaspartate composition. The NCO groups in excess of the NH groups in the coating composition typically react with moisture from the environment, residual moisture carried by solvents or other components, etc.

The coating composition typically comprises an additive component comprising any number of useful additives known in the coating art. Typically, for example, the additive component comprises a curing catalyst, a UV absorber and/or light-stabilizer, a rheology modifier, an adhesion promotor, a moisture scavenger, a wetting agent, a chain extender, a binder, a levelling and/or flow promotor, or a combination thereof. However, it will be appreciated that the coating composition may be substantially free from any one or more of these additives and, likewise, may include additives not specifically denoted above. Specific additives, selection criteria, and useful amounts thereof, are set forth in US2020031982A1, which is hereby incorporated by reference in its entirety. The additives may be added in the usual amounts familiar to the person skilled in the art. Pigments, fillers, and additives generally used for paint may be used in one and/or both components of the two-component system.

Additives may be employed in Part A, Part B, or both, as denoted above with respect to the two-component form of the coating composition. For example, in some embodiments, a curing catalyst is utilized (e.g. dibutyltin dilaurate, at about 0 to about 1500 ppm based on total binder solids), and formulated into Part B of the composition. In these or other embodiments, at least one of a UV absorber and/or light-stabilizer, a rheology modifier, a wetting agent, a levelling and/or flow promotor, or a combination thereof is utilized in the coating composition, and formulated into Part A. In these or other embodiments, at least one of an adhesion promotor, a moisture scavenger, a chain extender, a binder, or a combination thereof is utilized in the coating composition, and formulated into Part B.

In typical embodiments Part A and Part B each include organic solvent or a mixture of organic solvents as a liquid carrier. For example, in some embodiments, n-butyl acetate is used as a solvent in Part A and Part B. In other embodiments, one or both of Part A and Part B is substantially free from organic solvent.

The coating compositions, according to the disclosure, can further contain pigments, fillers and/or usual coating additives. All color and/or special effect-giving pigments of organic or inorganic type used in paints are suitable for pigments. Examples of inorganic or organic color pigments are titanium dioxide, micronized titanium dioxide, iron oxide pigments, carbon black, azo pigments, phthalocyanine pigments, quinacridone or pyrrolopyrrole pigments. Examples of special effect pigments are metal pigments, for example, from aluminum or copper, interference pigments, such as, for example, aluminum coated with titanium dioxide, coated mica and graphite effect pigments. Examples of fillers are silicon dioxide, barium sulphate, talcum, aluminum silicate and magnesium silicate.

As will be understood from the examples below, in some embodiments, the coating composition prepares a coating that exhibits certain performance metrics. For example, the coating may exhibit an AMTEC gloss retention after reflow (60° C.) of at least about 70%, alternatively of at least about 75%, alternatively of at least about 80%. In specific embodiments, the coating composition comprises the multi-polyaspartate composition, and prepares a coating that exhibits an AMTEC gloss retention after reflow (60° C.) of at least about 3% higher than an expected value based on performance of comparative single-polyaspartate compositions (i.e., coatings prepared from but one polyaspartate resin). These and other performance metrics are described in additional detail below.

A method for coating a substrate with the the coating compositions is also provided. Specifically, the method includes coating at least a portion of a substrate (e.g. a metal and/or plastic substrate, bare or pre-coated) with the coating composition; and curing the coating composition to give a coating on the substrate, thereby preparing a coated article.

In some embodiments, curing the coating composition is carried out by means of thermal energy and/or chemical reaction.

The substrate may be metal or plastic. Metallic substrates can be any industrial goods to be coated with one-component coating compositions or two-component coating compositions, in some embodiments two-component coating compositions such as two-component polyurethane coating compositions. Exemplary metallic substrates are vehicle bodies and vehicle body parts. Metallic substrates which may be used are the various materials, e.g. used in industrial coating and vehicle construction, for example, metals, such as, iron, zinc, aluminum, magnesium, stainless steel or the alloys thereof.

Plastic substrates can be any industrial goods to be coated with one-component coating compositions or two-component coating compositions, in some embodiments two-component coating compositions such as two-component polyurethane coating compositions. Exemplary plastic substrates are vehicle bodies and vehicle body parts. Plastic substrates which may be used are the various materials, e.g. used in industrial coating and vehicle construction, for example, polypropylene (PP), polyethylene (PE), polyurethane (PU), polyester (PES), polyamide (PA), poly(meth)acrylate, thermoplastic olefin such as blends of polypropylene (PP) and ethylene/propylene-diene rubber (EPDM), polycarbonate (PC), acrylonitrile butadiene styrene (ABS) and blends thereof such as blends of acrylonitrile butadiene styrene (ABS) and polycarbonate (PC) or blends of polycarbonate (PC) and polybutylene terephthalate (PBT), sheet molding compound (SMC), blends of poly(phenylene oxide) (PPO) and polyamide (PA) and mixtures thereof.

The coating composition may be applied by conventional application methods. Examples of application methods are brushing, roller application, knife coating, dipping and spraying. Spray application is exemplary. After an optional flash-off phase, the coating layers may then be cured and/or the next coating layer is applied. In specific embodiments, the coating composition is applied in a two-coat process.

In some embodiments, the applied coating composition is cured for example, at temperatures of from about −30 to about 75° C., such as from about −25 to about 70° C., alternatively of from about −18 to about 65° C., alternatively from about −12 to about 60° C., alternatively from about 0 to about 60° C. Typically, a curing temperature of from about ambient temperature to about 65° C. is utilized. In some embodiments, for example, an ambient cure is utilized, with conditions of about ambient temperature (e.g. room temperature, ±about 10° C., alternatively ±about 5° C.). In other embodiments, an elevated temperature is utilized. For example, in specific embodiments the applied coating composition via baking at from about 37 to about 70° C., such as from about 43 to about 60° C.

In specific embodiments, the curing is moisture sensitive, and the cure speed can be tailored by altering the drying temperature for a given humidity condition. For example, when the absolute humidity given by a temperature and relative humidity is high, air drying is typically utilized. When the absolute humidity is low, baking is typically utilized to cure the coating, e.g. to speed up the curing. It will be appreciated that the potlife of the coating composition may also be affected by temperature and/or humidity, such that controlling a storage and/or application atmosphere may be utilized to extend the potlife beyond the ranges described herein. However, those of skill in the art will appreciate that controlling temperature and humidity may be difficult to achieve on a commercial scale, and thus different techniques and or solutions (e.g. controlled atmosphere (CA) rooms, etc.) may be employed to affect such control on a small-scale vs. large scale setup.

The method in some embodiments includes applying multiple layers of coating compositions to at least a portion of a metallic or plastic substrate. In this regard, it is appreciated that at least one layer, in some embodiments one layer, of the multiple layers includes the instant coating composition. Accordingly, the further layers of the multiple layers can also include the instant coating composition or a coating composition differing from the instant coating composition. Thus, the instant coating composition can be adjacent to the metallic or plastic substrate, or the optional pre-coat, or an intercoat (or interlayer) of the multiple layer structure or the outer layer of the multiple layers.

The multiple layers are in some embodiments applied either wet on wet or by first curing one layer before applying the next layer of the multiple layers. If the multiple layers are applied by first curing one layer before applying the next layer of the multiple layers, the one layer is in some embodiments first cured for a sufficient time and at a sufficient temperature before the next layer of the multiple layers is applied. Regarding the curing temperature, it is referred to the temperatures set out above when defining the curing temperature of the applied coating composition.

It is appreciated that the coating composition of the present disclosure features a well-balanced drying performance, i.e., fast curing times at a sufficient potlife, in some embodiments a potlife of at least 30 min at room temperature and ambient humidity; mechanical properties such as scratch resistance, adhesion and interlayer adhesion in a multi-layer structure; chemical and corrosion resistance; and optical properties, such as coating appearance in terms smoothness and gloss.

The coating composition and the method, according to the disclosure, are suitable for automotive and industrial coatings. In the automotive coatings sector, the coatings and the method can be used for coating vehicle bodies and vehicle body parts in both vehicle production line painting and vehicle refinishing, e.g. on-line or in separate booths or spare part painting such as in-, on- or off-line. They can also be used for coating large vehicles and transportation vehicles, such as, trucks, busses, and railroad cars, where curing temperatures of from −20 to 150° C., in some embodiments from −10 to 150° C., more in some embodiments from 0 to 150° C. and most in some embodiments from 10 to 150° C., such as from 10 to 140° C., can be used. Most exemplary the coating compositions and the method can be used in vehicle and vehicle part refinishing. For refinishing, curing temperatures of, for example, −10 to 80° C., in some embodiments from 0 to 80° C. and most in some embodiments from 10 to 70° C., such as from 10 to 60° C., are used. Furthermore, the coating composition and the method can be used for coating any industrial goods other than motor vehicles.

The disclosure will be explained in more detail on the basis of the examples below.

### EXAMPLES

The following examples, illustrating embodiments of this disclosure, are intended to illustrate and not to limit the invention.

All parts and percentages are reported on a weight basis unless otherwise indicated. If provided, molecular weights (both number and weight average molecular weight) referred to herein may be determined by conventional methods known in the art. For example, molecular weights for polyaspartate resins can be determined via gel permeation chromatography (GPC), e.g. using polystyrene standards and a tetrahydrofuran (THF) eluent. Unless otherwise indicated, molecular weights are reports as weight average molecular weight (Mw).

### Measurement Methods

The following measurement methods are used to evaluate the parameters given in the examples and claims.

Viscosity: Viscosity of activated coating solution is determined according to a method based on ASTM D 4212. The measurement is carried out using a Zahn 2 flow cup, at room temperature (20±3° C.) and a relative humidity of around 30%.

Potlife: Potlife is measured by determining the solution viscosity (e.g. Zahn 2 flow cup) increase over time. The potlife is defined as the time required for the viscosity to reach to 1.5 times of the initial value, and represents the period during which a coating composition is still easy to spray.

Hardness: Samples are prepared by applying a coating on a glass plate to a dry film thickness of about 50 micron. Martens hardness is measured using a Fischer hardness tester (FisherScope HM2000S) with a Vickers indenter (indentation hardness ASTM E2546). A maximum load of 5 mN is used, with a loading time of 5 seconds. The results are expressed in MPa. Hardness is measured 2 hours, 24 hours, and 7 days of air drying after coatings are applied (sprayed).

Solids Content: The weight percentage of solids in a resin is determined according to a method based on DIN EN ISO 3251. A weighed sample of the resin (approximately 1 g) is loaded into an aluminum dish with a diameter of 75 mm containing a paperclip. The loaded dish is placed in an oven at about 105° C. (±1° C.) for about 1 hour and weighed again. The weight percentage of solids is calculated by using the Formula (I):

$$\% solids = 100 \% \times ( residue weight / sample weight ) \qquad ( I )$$

The reported solids are determined by measuring two samples, and averaging the results.

Amine value: Amine value is measured on solution determined according to a method based on DIN 53176, and reported in terms of eq. mg KOH/g. A sample is diluted in methoxy propanol and subsequently titrated using perchloric acid. The amine value (AV) is calculated according to formula (II):

$$A V = \frac{V * 56.1 * C}{Sample ( g )} [ mgKOH / g ] \qquad ( II )$$

where V is the volume (mL) used of perchloric acid having a concentration C (e.g. 0.1 mol/L).

Adhesion: E-coat panels (4 in by 12 in) coated with a primer layer adjacent to the e-coat, and a basecoat (e.g., water-based basecoat) adjacent to the primer layer, and then a clearcoat on the top are evaluated in coating adhesion. This test method is based on ASTM D2247-92 and ASTM D3359-92A. Dry and wet adhesion have been evaluated with both the cross-cut (X-hatch) and grid hatch (#-hatch) tape tests. In the X-hatch test, two cuts in the coating are made, each about 40 mm long that intersect near their middle with a smaller angle (between 30 and 45 degrees). In the #-hatch test, a grid hatch is made with a manual cross cut tester, where the lines are 1 mm apart from each other. The panels are brushed lightly to remove any detached flakes of coating. To ensure good contact with the film, a scotch tape is placed over the X-cut and grid areas and rubbed with a rubber eraser to ensure good contact. Within 60 to 120 seconds after application, the tape is removed by seizing the free end and pulling it off rapidly back upon itself at an angle as close as possible to 180 degrees.

The dry adhesion is rated from 0 (total failure) to 10 (no failure) according to the extent of damage, which can be assessed by visual comparison against standards (e.g. actual, photographic, diagrammatic, etc.).

For the evaluation of wet adhesion the same method is used but here the panels are placed for 10 days in a humidity cabinet which is at 100% RH and 40° C. The adhesion of the coatings is assessed at 1 hour and 24 hours after the panels are pulled out of the humidity cabinet. Similar to the dry adhesion, the wet adhesion is rated from 0 (total failure) to 10 (no failure) according to the extent of the damage. Observed blisters after the humidity treatment are also counted and measured on each panel (4 inches by 12 inches). The diameter of the largest blister in millimeters on each panel is recorded. Formation of big blisters is another indication of weak wet adhesion besides the cross-cut (X-hatch) and grid hatch (#-hatch) tape tests.

Gloss: Gloss is determined on coating samples one day after spraying. Gloss is measured with a micro TRI gloss device from Byk Gardner (Germany), with reflected light measured at an angle of 20°.

Distinctness of Image (DOI) and Dullness (du): Distinctness of Image (DOI) and Dullness (du) are determined on coating samples one day after spraying. Samples are assessed with a Wavescan-DOI apparatus from Byk Gardner (Germany), which uses a CCD camera to measure diffused light caused by fine (e.g. <1 mm) and very fine (e.g. <0.1 mm) surface structures and report DOI and du values.

DOI can also be described with terms like brilliance, sharpness or clarity. DOI is diminished by fine structures close to the human eye resolution (i.e., smaller than 1 mm). A higher value for DOI is desired.

Structures smaller than 0.1 mm influence visual perception and are used to determine a parameter referred to as the ‘dullness’ of the coating. A lower value for dullness (du) is desired, with a minimum value of 1.

Materials: Unless otherwise noted, all solvents, substrates, and reagents are purchased or otherwise obtained from various commercial suppliers (e.g. BASF, Covestro, Evonik, Sigma-Aldrich, VWR, Alfa Aesar, etc.) and utilized as received (i.e., without further purification) or as in a form used conventionally in the art.

Isophoronediamine (IPDA) is commercially available from Evonik Industries, Germany, BASF SE, Germany or DKSH, China, Switzerland.

Isophorone diisocyanate (IPDI) is commercially available from Evonik Industries, Germany and Covestro AG, Germany.

Dialkyl butenedioate compounds (e.g. dialkyl maleates), including diethyl maleate (DEM), dibutyl maleate (DBM), and bis(2-ethylhexyl) maleate (i.e., dioctyl maleate, DOM) are commercially available from numerous commercial sources, including DSM Fine Chemicals, Austria and Polynt S. p. A., Italy.

Arylate compounds including 1,6-hexanediol diacrylate (HDDA), trimethylolpropane triacrylate (TMPTA), and methyl acrylate are commercially available from numerous commercial sources, including BASF SE, Germany, ECEM, Netherlands and DOW Benelux, Netherlands.

Solvent/Diluent 1 is butyl acetate (i.e., n-butylacetate), commercially available from BASF SE, Germany, Celanese, USA or Oxea GmbH, Germany.

Solvent/Diluent 2 is propylene glycol monomethyl ether acetate (PGMEA), commercially available from BASF SE, Germany, the Dow Chemical Company, USA or Lyondell Basell, Germany.

Solvent/Diluent 3 is butyl glycol acetate (BGA), commercially available from BASF SE, Germany or Ineos Oxide.

Solvent/Diluent 4 is an aromatic fluid (e.g. Aromatic 100 Fluid), commercially available from numerous sources.

UV Additives comprises a benzotriazole UV absorber (e.g. Tinuvin 384-2) and UV stabilizer (e.g. Tinuvin 292) commercially available from BASF SE.

S/A Additives comprises silicone and acrylic additives, commercially available from Byk Chemie GmbH, Germany, as Byk 315, Byk 361, and Baysilone OL17 from OMG Borchers.

Curing Agent 1 is an aliphatic polyisocyanate (HDI trimer) (e.g. Desmodur N 3300A).

Adhesion Promotor 1 is a silane composition (e.g. Silquest A187).

Moisture Scavenger 1 is p-toluenesulfonyl isocyanate (pTSI).

Catalyst 1 is dibutyltin dilaurate (DBTDL) in butyl acetate (10% wt.).

It will be understood that various materials set forth above and utilized in the examples below are identified by technical and/or trade names, and exemplify the components of the embodiments described herein. For example, 1,6-hexanediol diacrylate (HDDA) and trimethylolpropane triacrylate (TMPTA) represent particular selections suitable as multi-functional acrylate component (A); diethyl maleate (DEM), dibutyl maleate (DBM), and bis(2-ethylhexyl) maleate (i.e., dioctyl maleate, DOM) represent particular selections suitable as dialkyl butenedioate (B); isophoronediamine (IPDA) represents a particular selection suitable as multi-functional primary amino compound (C); and isophorone diisocyanate (IPDI) represents a particular selections suitable as isocyanate chain extender (II). Comparative compounds will also be understood, including methyl acrylate (MA), which is a mono-functional acrylate component in contrast to component (A).

### PREPARATION EXAMPLES

Various aspartate compositions are prepared below in Examples 1-5, with additional parameters and details set forth further below in Table 1.

### Example 1A: A Bisaspartate of Isophoronediamine, Bis(2-ethylhexyl) Maleate and Trimethylolpropane Triacrylate (Aspartate Composition 1)

In a reactor equipped with a propeller type of stirrer, a thermocouple, condenser and feeding funnel 349.06 g of isophoronediamine (IPDA), 5.03 g of 2,6-di-tert-butyl-4-methylphenol, and 26.49 g of n-butylacetate were loaded under nitrogen blanket. The mixture was heated to 35° C. 349.51 g of bis(2-ethylhexyl) maleate (DOM) was added to the reactor content while maintaining temperature below 75° C. After 5 minutes the temperature of the reaction content was set to 50° C. and kept for 1.5 hours. In the second step, 349.51 g of bis(2-ethylhexyl) maleate (DOM) was added to the reactor content while maintaining temperature below 75° C. After 5 minutes the temperature of the reaction content was set to 60° C. and kept for 1.5 hours. In the third step, 349.51 g of bis(2-ethylhexyl) maleate (DOM) and 101.39 g of trimethylolpropane triacrylate (TMPTA) were added to the reactor content while maintaining temperature below 75° C. After the rinsing step with 69.51 g of n-butylacetate, the reactor temperature was kept at 70° C. for 30 hours.

### Example 1B: Isophorone Diisocyanate Chain Extended Reaction Product of Example 1A (Resin 1)

In a reactor equipped with a propeller type of stirrer, a thermocouple, condenser and feeding funnel, 780.00 g of the reaction product of example 1A (Aspartate Composition 1) was loaded. The reaction content was heated to 50° C., followed by a dilution step with 160.00 g of n-butylacetate. Then, 77.23 g of isophorone diisocyanate (IPDI) was added slowly to the reactor, maintaining the temperature of the reaction content below 60° C. After the rinsing step with 19.16 g of n-butylacetate, the reactor content was kept at 70° C. for 2 h. In a dilution step, 117.27 g of n-butylacetate was added to the reactor. The product resin, Resin 1, is set forth and used in further examples below.

### Example 2A: A Bisaspartate of Isophoronediamine, Bis(2-Ethylhexyl)maleate and 1,6-Hexanediol Diacrylate (Aspartate Composition 2)

In a reactor equipped with a propeller type of stirrer, a thermocouple, condenser and feeding funnel 345.66 g of isophoronediamine (IPDA), 5.03 g of 2,6-di-tert-butyl-4-methylphenol, and 26.49 g of n-butylacetate was loaded under nitrogen blanket. The mixture was heated to 35° C. 346.10 g of bis(2-ethylhexyl) maleate (DOM) was added to the reactor content while maintaining temperature below 75° C. After 5 minutes the temperature of the reaction content was set to 50° C. and kept for 1.5 hours. In the second step 346.10 g of bis(2-ethylhexyl) maleate (DOM) was added to the reactor content while maintaining temperature below 75° C. After 5 minutes the temperature of the reaction content was set to 60° C. and kept for 1.5 hours. In the third step 346.10 g of bis(2-ethylhexyl) maleate (DOM) and 115.00 g of 1,6-hexanediol diacrylate (HDDA) were added to the reactor content while maintaining temperature below 75° C. After the rinsing step with 69.51 g of n-butylacetate, the reactor temperature was kept at 70° C. for 30 hours.

### Example 2B: Isophorone Diisocyanate Chain Extended Reaction Product of Example 2A (Resin 2)

In a reactor equipped with a propeller type of stirrer, a thermocouple, condenser and feeding funnel 762.00 g of the reaction product of example 2A (Aspartate Composition 2) was loaded and heated in the reactor to 50° C., followed by a dilution step with 156.31 g of n-butylacetate. Then, 74.72 g of isophorone diisocyanate (IPDI) was added slowly to the reactor maintaining the reaction temperature below 60° C. In the next step, 18.53 g of n-butylacetate was added, and the reactor content was kept at 70° C. for 2 h. In a dilution step, 114.47 g of n-butylacetate was added to the reactor. The product resin, Resin 2, is set forth and used in further examples below.

### Example 3: Isophorone Diisocyanate Chain Extended Bisaspartate of Isophoronediamine, Dibutyl Maleate and 1,6-Hexanediol Diacrylate (Resin 3)

In a reactor equipped with a propeller type of stirrer, a thermocouple, condenser and feeding funnel 278.92 g of isophoronediamine (IPDA), 3.32 g of 2,6-di-tert-butyl-4-methylphenol, and 17.49 g of n-butylacetate were loaded under nitrogen blanket. The mixture was heated to 35° C. 224.68 g of dibutyl maleate (DBM) was added to the reactor content while maintaining temperature below 75° C. After 5 minutes the temperature of the reaction content was set to 50° C. and kept for 1.5 hours. In the second step 224.68 g of dibutyl maleate (DBM) was added to the reactor content while maintaining temperature below 75° C. After 5 minutes the temperature of the reaction content was set to 60° C. and kept for 1.5 hours. In the third step, 224.68 g of dibutyl maleate (DBM) and 37.12 g of 1,6-hexanediol diacrylate (HDDA) were added to the reactor content while maintaining temperature below 75° C. After the rinsing step with 45.92 g of n-butylacetate, the reactor temperature was kept at 70° C. for 30 hours, followed by cooling to 50° C. and diluting the reaction content with 216.78 g of n-butylacetate. Then, 126.59 g of isophorone diisocyanate (IPDI) was added slowly to the reactor maintaining the reaction temperature below 60° C. In the next step, 35.70 g of n-butylacetate was added and the reactor content was kept at 70° C. for 2 h. In a dilution step, 164.11 g of n-butylacetate was added to the reactor. The product resin, Resin 3, is set forth and used in further examples below.

### Comparative Example 1A: A Bisaspartate of Isophoronediamine, Bis(2-Ethylhexyl) Maleate and Methyl Acrylate (Aspartate Composition 4)

In a reactor equipped with a propeller type of stirrer, a thermocouple, condenser and feeding funnel, 352.12 g of isophoronediamine (IPDA), 5.03 g of 2,6-di-tert-butyl-4-methylphenol, and 26.49 g of n-butylacetate were loaded under nitrogen blanket. The mixture was heated to 35° C. 352.57 g of bis(2-ethylhexyl) maleate (DOM) was added to the reactor content while maintaining temperature below 75° C. After 5 minutes the temperature of the reaction content was set to 50° C. and kept for 1.5 hours. In the second step 352.57 g of bis(2-ethylhexyl) maleate (DOM) was added to the reactor content while maintaining temperature below 75° C. After 5 minutes the temperature of the reaction content was set to 60° C. and kept for 1.5 hours. In the third step 352.57 g of bis(2-ethylhexyl) maleate (DOM) and 89.14 g of methyl acrylate (MA) was added to the reactor content while maintaining temperature below 75° C. After the rinsing step with 69.51 g of n-butylacetate, the reactor temperature was kept at 70° C. for 30 hours.

### Comparative Example 1B: Isophorone Diisocyanate Chain Extended Reaction Product of Comparative Example 1A (Resin 4)

In a reactor equipped with a propeller type of stirrer, a thermocouple, condenser, and feeding funnel, 777.00 g of the reaction product of comparative example 1A (Aspartate Composition 4) was loaded. The reaction content was heated to 50° C., followed by a dilution step with 159.39 g of n-butylacetate. Then, 77.61 g of isophorone diisocyanate (IPDI) was added slowly to the reactor maintaining the temperature of the reaction content below 60° C. After the rinsing step with 19.27 g of n-butylacetate, the reactor content was kept at 70° C. for 2 h. In a dilution step, 116.91 g of n-butylacetate was added to the reactor. The product resin, Resin 4, is set forth and used in further examples below.

### Comparative Example 2A: A Bisaspartate of Isophoronediamine and Diethylmaleate (Aspartate Composition 5)

In a reactor equipped with a propeller type of stirrer, a thermometer, condenser and feeding system, 204.91 g of isophorone diamine (IPDA) and 34.44 g of n-butylacetate were loaded. The mixture was heated to 30° C. 414.99 g of diethyl maleate (DEM) and 10.33 g of n-butylacetate were fed to the reactor content over about 4 hours followed by a rinsing step with 10.33 g of n-butylacetate. The reactor temperature was kept at 50° C. max during addition and for 46 hours after the addition was completed.

### Comparative Example 2B: Isophorone Diisocyanate Chain Extended Reaction Product of Comparative Example 2A (Resin 5)

688.78 g of the reaction product of Comparative Example 2A (Aspartate Composition 5) was diluted with 151.62 g of n-butylacetate and heated in the reactor to 40° C. 80.82 g of isophorone diisocyanate (IPDI) mixed with 16.89 g of n-butylacetate was added to the reactor over 1 hour while the reactor was kept at a temperature no higher than 50° C. After a rinsing step with 16.89 g of n-butylacetate, the reactor content was kept at 50° C. until the NCO functional groups were not detectable via IR spectroscopy. In a dilution step, 45 g of n-butylacetate was added to the reactor.

Additional information regarding Aspartate Composition 5 and Resin 5 above is reported in U.S. Pat. No. 10,519,336, the contents of which are incorporated by reference herein.

The product resin of Comparative Example 2B, Resin 5, is set forth and used in further examples below.

TABLE 1
Asymmetric Aspartate Resins of Examples
1-3 and Comparative Examples 1-2

| Example | 1 | 2 | 3 | CE1 | CE2 |
|---|---|---|---|---|---|
| DBM (eq.): | — | — | 0.9 | — | — |
| DOM (eq.): | 0.75 | 0.75 | — | 0.75 | — |
| DEM (eq.): | — | — | — | — | 1 |
| MA (eq.): | — | — | — | 0.25 | — |
| HDDA (eq.): | — | 0.25 | 0.1 | — | — |
| TMPTA (eq.): | 0.25 | — | — | — | — |
| IPDA (eq.): | 1.00 | 1.00 | 1.00 | 1.00 | 1.00 |
| Aspartate Composition: | AC-1 | AC-2 | n/a | AC-4 | AC-5 |
| Solids (wt. %): | 95.71 | 97.25 | n/a | 96.87 | 82.6 |
| Amine value (mgKOH/ | 143.21 | 145.93 | n/a | 150.63 | 185 |
| g): | | | | | |
| IPDI (eq.): | 0.35 | 0.35 | 0.35 | 0.35 | 0.30 |
| Resin: | Resin 1 | Resin 2 | Resin 3 | Resin 4 | Resin 5 |
| Solids (wt. %): | 72.44 | 73.97 | 68.58 | 73.79 | 67.44 |
| Amine value (mgKOH/ | 65.22 | 67.43 | 75.84 | 70.8 | 94.58 |
| g): | | | | | |

### Formulation Example 1: General Procedure

In an exemplary embodiment, clearcoat compositions are formed by mixing a part A and a part B together to form a homogenous solution. Part A includes one or two polyaspartate resins, solvent, UV absorbers and stabilizers, flow and levelling additives. Part B includes polyisocyanate, silane additives, moisture scavengers, catalyst, and solvent. Parts A and B of the Example Curable Coatings 1-16 and Comparative Curable Coatings 1-6, prepared in differing spray forms according to the general process described above, are shown in Tables 2-5 below.

TABLE 2
Coating Compositions using Resins 1 & 5
Resin 1/Resin 5 mix; Spray 1-1

| | | | | | |
|---|---|---|---|---|---|
| Curable Coating: | 1 | 2 | 3 | 4 | 5 |

Part A

| | | | | | |
|---|---|---|---|---|---|
| Resin 1 | 51.79 | 44.43 | 37.36 | 33.24 | 24.01 |
| Resin 5 | 0.00 | 6.82 | 13.38 | 17.19 | 25.79 |
| Solvent/Diluent 1 | 16.63 | 15.93 | 15.25 | 14.87 | 13.91 |
| UV Additives | 2.26 | 2.26 | 2.26 | 2.27 | 2.27 |
| S/A Additives | 0.36 | 0.36 | 0.36 | 0.36 | 0.36 |
| Solvent/Diluent 2 | 1.38 | 1.38 | 1.38 | 1.38 | 1.38 |
| Solvent/Diluent 3 | 1.31 | 1.31 | 1.31 | 1.31 | 1.31 |
| Part A Sum | 73.73 | 72.49 | 71.30 | 70.61 | 69.03 |

Part B

| | | | | | |
|---|---|---|---|---|---|
| Curing Agent 1 | 15.22 | 15.97 | 16.69 | 17.10 | 18.05 |
| Solvent/Diluent 4 | 0.85 | 0.89 | 0.93 | 0.95 | 1.00 |
| Solvent/Diluent 1 | 9.20 | 9.65 | 10.08 | 10.33 | 10.91 |
| Adhesion Promotor | 0.84 | 0.84 | 0.84 | 0.84 | 0.84 |
| Moisture Scavenger | 0.05 | 0.05 | 0.06 | 0.06 | 0.06 |
| Catalyst | 0.11 | 0.11 | 0.11 | 0.11 | 0.11 |
| Part B Sum | 26.27 | 27.51 | 28.70 | 29.39 | 30.97 |
| Total: | 100.00 | 100.00 | 100.00 | 100.00 | 100.00 |

TABLE 3
Coating Compositions using Resins 2 & 5
Resin 2/Resin 5 mix; Spray 1-1

| | | | | | |
|---|---|---|---|---|---|
| Curable Coating: | 6 | 7 | 8 | 9 | 10 |

Part A

| | | | | | |
|---|---|---|---|---|---|
| Resin 2 | 50.54 | 43.92 | 36.49 | 32.48 | 23.45 |
| Resin 5 | 0.00 | 6.88 | 13.34 | 17.15 | 25.72 |
| Solvent/Diluent 1 | 17.65 | 16.08 | 16.00 | 15.52 | 14.49 |
| UV Additives | 2.27 | 2.29 | 2.27 | 2.27 | 2.27 |
| S/A Additives | 0.36 | 0.36 | 0.36 | 0.36 | 0.36 |
| Solvent/Diluent 2 | 1.38 | 1.39 | 1.38 | 1.38 | 1.36 |
| Solvent/Diluent 3 | 1.31 | 1.32 | 1.31 | 1.31 | 1.30 |
| Part A Sum | 73.51 | 72.24 | 71.15 | 70.47 | 68.95 |

Part B

| | | | | | |
|---|---|---|---|---|---|
| Curing Agent 1 | 15.36 | 16.12 | 16.78 | 17.18 | 18.10 |
| Solvent/Diluent 4 | 0.85 | 0.90 | 0.93 | 0.95 | 1.01 |
| Solvent/Diluent 1 | 9.28 | 9.74 | 10.14 | 10.38 | 10.94 |
| Adhesion Promotor | 0.84 | 0.85 | 0.84 | 0.84 | 0.84 |
| Moisture Scavenger | 0.05 | 0.06 | 0.06 | 0.06 | 0.06 |
| Catalyst | 0.11 | 0.11 | 0.11 | 0.11 | 0.11 |
| Part B Sum | 26.49 | 27.76 | 28.85 | 29.53 | 31.05 |
| Total: | 100.00 | 100.00 | 100.00 | 100.00 | 100.00 |

TABLE 4
Comparative Coating Compositions using Comparative Resins 4 & 5
Resin 4/Resin 5 mix; Spray 1-2 (Comparative)

| | | | | | | |
|---|---|---|---|---|---|---|
| Curable | | | | | | |
| Coating: | CCE1 | CCE2 | CCE3 | CCE4 | CCE5 | CCE6 |

Part A

| | | | | | | |
|---|---|---|---|---|---|---|
| Resin 4 | 0.00 | 50.02 | 42.93 | 36.18 | 32.24 | 23.34 |
| Resin 5 | 47.99 | 0.00 | 6.71 | 13.20 | 16.99 | 25.54 |
| Solvent/Diluent | 11.62 | 17.37 | 16.55 | 15.79 | 15.34 | 14.33 |
| 1 | | | | | | |
| UV Additives | 2.27 | 2.26 | 2.27 | 2.26 | 2.27 | 2.27 |
| S/A Additives | 0.37 | 0.36 | 0.36 | 0.36 | 0.36 | 0.36 |
| Solvent/Diluent | 1.42 | 1.38 | 1.38 | 1.38 | 1.38 | 1.38 |
| 2 | | | | | | |
| Solvent/Diluent | 1.35 | 1.31 | 1.31 | 1.31 | 1.31 | 1.31 |
| 3 | | | | | | |
| Part A Sum | 65.01 | 72.71 | 71.51 | 70.49 | 69.89 | 68.54 |

Part A

| | | | | | | |
|---|---|---|---|---|---|---|
| Curing | 20.46 | 15.84 | 16.56 | 17.17 | 17.53 | 18.34 |
| Agent 1 | | | | | | |
| Solvent/Diluent | 1.14 | 0.88 | 0.92 | 0.95 | 0.97 | 1.02 |
| 4 | | | | | | |
| Solvent/Diluent | 12.37 | 9.57 | 10.01 | 10.38 | 10.59 | 11.08 |
| 1 | | | | | | |
| Adhesion | 0.85 | 0.84 | 0.84 | 0.84 | 0.84 | 0.84 |
| Promotor | | | | | | |
| Moisture | 0.07 | 0.05 | 0.06 | 0.06 | 0.06 | 0.06 |
| Scavenger | | | | | | |
| Catalyst | 0.11 | 0.11 | 0.11 | 0.11 | 0.11 | 0.11 |
| Part B Sum | 34.99 | 27.29 | 28.49 | 29.51 | 30.11 | 31.46 |
| Total: | 100.00 | 100.00 | 100.00 | 100.00 | 100.00 | 100.00 |

TABLE 5
Coating Compositions using Resins 1 & 3
Resin 1/Resin 3 mix; Spray 2

| Curable | | | | | | |
|---|---|---|---|---|---|---|
| Coating: | 11 | 12 | 13 | 14 | 15 | 16 |

Part A

| | | | | | | |
|---|---|---|---|---|---|---|
| Resin 1 | 0.00 | 9.62 | 19.01 | 28.19 | 37.15 | 51.91 |
| Resin 3 | 51.42 | 40.64 | 30.12 | 19.85 | 9.81 | 0.00 |
| Solvent/Diluent | 13.07 | 13.53 | 13.98 | 14.40 | 14.83 | 16.44 |
| 1 | | | | | | |
| UV Additives | 2.27 | 2.27 | 2.27 | 2.26 | 2.27 | 2.26 |
| S/A Additives | 0.36 | 0.36 | 0.36 | 0.36 | 0.36 | 0.36 |
| Solvent/Diluent | 1.38 | 1.38 | 1.38 | 1.38 | 1.38 | 1.38 |
| 2 | | | | | | |
| Solvent/Diluent | 1.32 | 1.32 | 1.32 | 1.32 | 1.32 | 1.32 |
| 3 | | | | | | |
| Part A Sum | 69.81 | 69.12 | 68.44 | 67.77 | 67.12 | 73.67 |

Part B

| | | | | | | |
|---|---|---|---|---|---|---|
| Curing | 17.58 | 17.99 | 18.40 | 18.81 | 19.20 | 15.26 |
| Agent 1 | | | | | | |
| Solvent/Diluent | 0.98 | 1.00 | 1.02 | 1.04 | 1.07 | 0.85 |
| 4 | | | | | | |
| Solvent/Diluent | 10.62 | 10.87 | 11.12 | 11.37 | 11.60 | 9.22 |
| 1 | | | | | | |
| Adhesion | 0.85 | 0.84 | 0.84 | 0.84 | 0.84 | 0.84 |
| Promotor | | | | | | |
| Moisture | 0.06 | 0.06 | 0.06 | 0.06 | 0.07 | 0.05 |
| Scavenger | | | | | | |
| Catalyst 1 | 0.11 | 0.11 | 0.11 | 0.11 | 0.11 | 0.11 |
| Part B Sum | 30.19 | 30.88 | 31.56 | 32.23 | 32.88 | 26.33 |
| Total: | 100.00 | 100.00 | 100.00 | 100.00 | 100.00 | 100.00 |

Comparative curable coating (CCE1) shown in the table above, including only Resin 5 as the curable resin, is used to demonstrate the end point of the range of resin 5 weight percent based on the solid amounts of each resin in resin mixtures of Resin 1/Resin 5, Resin 2/Resin 5, and Resin 4/Resin 5.

### Coating Examples & Performance Analyses

E-coat panels (4 in by 12 in) were used to prepare coating layers including a primer layer, a basecoat layer, and a clearcoat with clearcoat compositions for appearance and performance testing. A glass plate was also sprayed with the same clearcoat for Martens hardness measurement. In particular, coating compositions 1-17 were prepared as set forth in the tables below, by first mixing together the binder portion A and the activator portion B of Curable Compositions (CC) 1-16 and Comparative Curable Compositions (CCE) 1-6 to form a homogenous solution. The homogeneous solution was then sprayed with a spray gun onto the e-coat panels in which each of the e-coat panels had a primer layer adjacent to the e-coat, and a basecoat (e.g., water-based basecoat) disposed thereon. Spraying was conducted using a two-coat process with about 5 minutes of flash in between the coats. After spraying, the clearcoat was air dried at an ambient condition. Appearance of the coated panels was measured after overnight drying. Martens hardness was measured after 2 hours, 24 hours, and 7 days of air drying. The coated panels were then allowed to age for a minimum of five days at room temperature and 64 hours of oven aging at a low temperature of 50° C. to accelerate the aging process. After aging, coated panels were tested on scratch resistance as discussed in further detail below. The thickness of the substantially fully cured clearcoat was about 50 μm.

Scratch resistance testing was conducted on the coated panels using the Amtec Test per DIN EN ISO 20566, using an Amtec Laboratory Car Wash Machine available from Amtec Kistler GmbH, Prittriching, Germany, which mimics a car wash. Per the Amtec Test, the coated panels were scratched with plastic brushes with the presence of a slurry. Then, the panels with scratched coatings went through a baking process at about 60° C. for 2 hours for recovery. The gloss values of the coatings before the Amtec test and after the scratch recovery (reflow) were measured. Gloss retention after reflow was calculated by using the gloss after the scratch reflow divided by the gloss before the Amtec test, as a measure of how much gloss can be maintained. Desirable gloss retention after reflow levels of the scratched coatings depend on OEM manufacturers, but typically, about 75% or higher gloss retention after reflow is highly desirable.

The results of the performance and appearance testing are set forth in Tables 6-9 below.

TABLE 6
Performance Analysis of Coating Compositions 1-6

| Coating | C-1 | C-2 | C-3 | C-4 | C-5 | C-6 |
|---|---|---|---|---|---|---|
| Curable Comp. | CC-1 | CC-2 | CC-3 | CC-4 | CC-5 | CCE1 |
| 1st Resin | 5 | 5 | 5 | 5 | 5 | 5 |
| 2nd Resin | 1 | 1 | 1 | 1 | 1 | None |
| Rel. % 1st Resin (solids) | 0 | 12.5 | 25 | 37.5 | 50 | 100 |
| Spray Form | 1-1 | 1-1 | 1-1 | 1-1 | 1-1 | 1-1 |
| Viscosity (sec.) | 23.96 | 22.34 | 21.38 | 21.74 | 20.80 | 18.65 |
| Potlife (min.) | 60.2 | 60.1 | 59.1 | 60.0 | 60.0 | 45.5 |
| DOI | 93.1 | 93.3 | 94.2 | 93.9 | 95 | 94.4 |
| Gloss | 78.6 | 80.2 | 82.2 | 82 | 83 | 83.5 |
| du | 5.7 | 5.4 | 4.1 | 4.7 | 2.9 | 3.3 |
| Gloss Retention After | 75.90 | 78.57 | 79.76 | 80.95 | 83.13 | 54.12 |
| Reflow after Amtec | | | | | | |
| test (%) | | | | | | |
| Exp. Gloss Retention | 75.90* | 73.18 | 70.46 | 67.73 | 65.01 | 54.12* |
| After Reflow (calc.) | | | | | | |
| Synergy Observed | 0 | 7 | 13 | 20 | 28 | 0 |
| Dry Adhesion, #-hatch | 10 | 10 | 10 | 10 | 10 | 9 |
| Dry Adhesion, X-hatch | 10 | 10 | 10 | 10 | 10 | 10 |
| Wet Adhesion, #-hatch, | 10 | 10 | 10 | 10 | 10 | 10 |
| 1-hr | | | | | | |
| Wet Adhesion, X-hatch, | 10 | 10 | 10 | 10 | 10 | 10 |
| 1-hr | | | | | | |
| Wet Adhesion, #-hatch, | 10 | 10 | 10 | 10 | 10 | 10 |
| 24-hr | | | | | | |
| Wet Adhesion, X-hatch, | 10 | 10 | 10 | 10 | 10 | 10 |
| 24-hr | | | | | | |
| Blister Count (#) | 0 | 0 | 0 | 0 | 0 | 6 |
| Blister Size (mm) | 0 | 0 | 0 | 0 | 0 | 4.3 |
| Martens Hardness, 2-hr | 2.65 | 4.20 | 6.95 | 10.90 | 19.90 | 53.50 |
| (Mpa) | | | | | | |
| Martens Hardness, 24-hr | 40.40 | 49.85 | 63.20 | 69.85 | 81.65 | 109.15 |
| (Mpa) | | | | | | |
| Martens Hardness, 7-day | 47.50 | 62.20 | 74.70 | 82.50 | 95.00 | 118.80 |
| (Mpa) | | | | | | |

TABLE 7
Performance Analysis of Coating Compositions 7-11

| Coating | C-7 | C-8 | C-9 | C-10 | C-11 |
|---|---|---|---|---|---|
| Curable Comp. | CC-6 | CC-7 | CC-8 | CC-9 | CC-10 |
| 1st Resin | 5 | 5 | 5 | 5 | 5 |
| 2nd Resin | 2 | 2 | 2 | 2 | 2 |
| Rel. % 1st Resin (solids) | 0 | 12.5 | 25 | 37.5 | 50 |
| Spray Form | 1-1 | 1-1 | 1-1 | 1-1 | 1-1 |
| Viscosity (sec.) | 30.78 | 27.75 | 25.13 | 23.60 | 21.22 |
| Potlife (min.) | 45.1 | 44.8 | 44.9 | 45.0 | 45.0 |
| DOI | 92.9 | 94.6 | 92.3 | 92.5 | 93.1 |
| Gloss | 82.9 | 83.6 | 83.6 | 83.5 | 82.5 |
| du | 5.1 | 3 | 5.8 | 6 | 4.5 |
| Gloss Retention After Reflow | 87.80 | 86.90 | 82.93 | 86.75 | 86.90 |
| after Amtec test (%) | | | | | |
| Exp. Gloss Retention After | 87.80* | 83.59 | 79.38 | 75.17 | 70.96 |
| Reflow (calc.) | | | | | |
| Synergy Observed | 0 | 4 | 4 | 15 | 22 |
| Dry Adhesion, #-hatch | 10 | 10 | 10 | 10 | 10 |
| Dry Adhesion, X-hatch | 10 | 10 | 10 | 10 | 10 |
| Wet Adhesion, #-hatch, 1-hr | 10 | 10 | 10 | 10 | 10 |
| Wet Adhesion, X-hatch, 1-hr | 10 | 10 | 10 | 10 | 10 |
| Wet Adhesion, #-hatch, 24-hr | 10 | 10 | 10 | 10 | 10 |
| Wet Adhesion, X-hatch, 24-hr | 10 | 10 | 10 | 10 | 10 |
| Blister Count (#) | 0 | 0 | 0 | 0 | 8 |
| Blister Size (mm) | 0 | 0 | 0 | 0 | 4 |
| Martens Hardness, 2-hr (Mpa) | 3.30 | 6.10 | 7.40 | 12.10 | 22.90 |
| Martens Hardness, 24-hr (Mpa) | 40.45 | 53.30 | 63.65 | 70.35 | 86.00 |
| Martens Hardness, 7-day (Mpa) | 47.75 | 60.85 | 71.75 | 79.75 | 94.00 |

TABLE 8
Performance Analysis of Coating Compositions 12-17

| Coating | C-12 | C-13 | C-14 | C-15 | C-16 | C-17 |
|---|---|---|---|---|---|---|
| Curable Comp. | CCE2 | CCE3 | CCE4 | CCE5 | CCE6 | CCE1 |
| 1st Resin | 5 | 5 | 5 | 5 | 5 | 5 |
| 2nd Resin | 4 | 4 | 4 | 4 | 4 | None |
| Rel. % 1st Resin (solids) | 0 | 12.5 | 25 | 37.5 | 50 | 100 |
| Spray Form | 1-2 | 1-2 | 1-2 | 1-2 | 1-2 | 1-2 |
| Viscosity (sec.) | 18.30 | 18.61 | 18.41 | 18.47 | 18.50 | 18.65 |
| Potlife (min.) | 120.0 | 135.5 | 75.7 | 75.2 | 60.2 | 45.5 |
| DOI | 95.6 | 95.7 | 95 | 95 | 94.7 | 94.3 |
| Gloss | 85.5 | 85.2 | 85.8 | 85.8 | 86.1 | 86.0 |
| du | 1 | 1 | 1.2 | 1 | 1.2 | 1.1 |
| Gloss Retention After Reflow | 65.12 | 62.79 | 54.65 | 77.91 | 58.62 | 54.12 |
| after Amtec test (%) | | | | | | |
| Exp. Gloss After Reflow (calc.) | 65.12 | 63.74 | 62.37 | 60.99 | 59.62 | 54.12* |
| Synergy Observed | 0 | −1 | −12 | 28 | −2 | 0 |
| Dry Adhesion, #-hatch | 10 | 10 | 10 | 10 | 10 | 10 |
| Dry Adhesion, X-hatch | 10 | 10 | 10 | 10 | 10 | 10 |
| Wet Adhesion, #-hatch, 1-hr | 10 | 10 | 10 | 10 | 10 | 10 |
| Wet Adhesion, X-hatch, 1-hr | 10 | 10 | 10 | 10 | 10 | 10 |
| Wet Adhesion, #-hatch, 24-hr | 10 | 10 | 10 | 10 | 10 | 10 |
| Wet Adhesion, X-hatch, 24-hr | 10 | 10 | 10 | 10 | 10 | 10 |
| Blister Count (#) | 0 | 0 | 0 | 0 | 0 | 3 |
| Blister Size (mm) | 0 | 0 | 0 | 0 | 0 | 4 |
| Martens Hardness, 2-hr (Mpa) | 3.40 | 1.80 | 6.70 | 8.75 | 21.55 | 36.85 |
| Martens Hardness, 24-hr (Mpa) | 58.25 | 46.75 | 68.90 | 74.80 | 87.65 | 108.05 |
| Martens Hardness, 7-day (Mpa) | 66.00 | 55.55 | 78.35 | 84.35 | 97.15 | 119.30 |

TABLE 9
Performance Analysis of Coating Compositions 18-23

| Coating | C-18 | C-19 | C-20 | C-21 | C-22 | C-23 |
|---|---|---|---|---|---|---|
| Curable Comp. | CC-11 | CC-12 | CC-13 | CC-14 | CC-15 | CC-16 |
| 1st Resin | 1 | 1 | 1 | 1 | 1 | 1 |
| 2nd Resin | 3 | 3 | 3 | 3 | 3 | 3 |
| Rel. % 1st Resin (solids) | 0 | 12.5 | 25 | 37.5 | 50 | 100 |
| Spray Form | 2 | 2 | 2 | 2 | 2 | 2 |
| Viscosity (sec.) | 19.50 | 20.32 | 21.42 | 22.03 | 23.14 | 25.61 |
| Potlife (min.) | 112.4 | 77.8 | 76.9 | 65.8 | 66.8 | 48.7 |
| DOI | 96.1 | 96.1 | 96.0 | 96.3 | 96.1 | 95.4 |
| Gloss | 85.7 | 85.9 | 86.0 | 86.0 | 85.8 | 84.9 |
| du | 1.0 | 1.0 | 1.0 | 1.0 | 1.0 | 2.1 |
| Gloss Retention After Reflow | 70.93 | 79.07 | 81.61 | 83.91 | 87.36 | 86.05 |
| after Amtec test (%) | | | | | | |
| Exp. Gloss Retention After | 70.93* | 72.82 | 74.71 | 76.60 | 78.49 | 86.05* |
| Reflow (calc.) | | | | | | |
| Synergy Observed | 0 | 9 | 9 | 10 | 11 | 0 |
| Dry Adhesion, #-hatch | 10 | 10 | 10 | 10 | 10 | 9 |
| Dry Adhesion, X-hatch | 10 | 10 | 10 | 10 | 10 | 10 |
| Wet Adhesion, #-hatch, 1-hr | 10 | 10 | 10 | 10 | 10 | 9 |
| Wet Adhesion, X-hatch, 1-hr | 10 | 10 | 10 | 10 | 10 | 10 |
| Wet Adhesion, #-hatch, 24-hr | 10 | 10 | 10 | 10 | 10 | 10 |
| Wet Adhesion, X-hatch, 24-hr | 10 | 10 | 10 | 10 | 10 | 10 |
| Blister Count (#) | 1 | 0 | 0 | 0 | 0 | 0 |
| Blister Size (mm) | 3.6 | 0 | 0 | 0 | 0 | 0 |
| Martens Hardness, 2-hr (Mpa) | 13.35 | 7.35 | 4.05 | 2.25 | 1.50 | 2.45 |
| Martens Hardness, 24-hr (Mpa) | 77.20 | 70.85 | 62.65 | 51.65 | 40.55 | 38.45 |
| Martens Hardness, 7-day (Mpa) | 85.20 | 80.65 | 74.60 | 69.10 | 62.60 | 49.00 |

In Tables 6-9, the actual values observed for single-resin compositions, denoted with an asterisk “*”, are used as the end-points for generating linear performance predictions for the multi-resin compositions, as described in further detail below.

As shown in Tables 6-9 above, the polyaspartate compositions of the present embodiments, utilizing the asymmetric polyaspartate resins described herein, demonstrate superior performance over conventional compositions utilizing conventional aspartate resins. Specifically, as can be seen from the exemplary coating compositions 1-11 and 18-23, the asymmetric polyaspartate resins 1-3 used to prepare curable compositions CC1-CC16 provide markedly improved Amtec scratch performance, while maintaining appearance, as compared to a baseline set by comparative coatings 12-17, which were prepared from comparative curable compositions CCE1-CCE6 comprising comparative resins 4 and/or 5. These superior results hold true over single-resin and multi-resin compositions of the present embodiments, i.e., multi-resin compositions comprising at least one of the asymmetric polyaspartate resins described herein.

As also shown in Tables 6-9 above, in the mixtures of Resin 1 and Resin 5, gloss retention after Amtec reflow was higher than what could be predicted from a linear response (additive effect) of the performance of Resin 1 and Resin 5 calculated based on the end points (i.e., 0% and 100% resin basis for a given resin in a mixture). A synergy factor was calculated by the relative increase of gloss retention after reflow to what could be predicted through the linear relationship:

$$Synergy factor = ( {GRAR}_{test} - {GRAR}_{exp} ) / {GRAR}_{exp} ,$$

where GRARₜₑₛₜ is the gloss retention after reflow obtained from the Amtec test. GRARₑₓₚ is the predicted or expected gloss retention after reflow through a linear function established by the values of gloss retention after reflow at two end points (i.e., 0% and 100% resin basis for a given resin in a mixture).

When a synergy factor is higher than 3%, which is the error of Amtec test in the same run (multiple panels tested at the same time), a synergy effect is considered present. In this set of mixtures, a strong synergy was present as the synergy factor went up to 28%. Similarly, in the mixtures of Resin 2 and Resin 5 shown in Table 7 above, gloss retention after reflow was higher than what could be predicted from the linear response of the performance of Resin 2 and Resin 5. The synergy factor went up to 22%. In the mixtures of Resin 3 and Resin 1 shown in Table 9 above, gloss retention after Amtec scratch reflow was higher than what could be predicted from the linear response of the performance of Resin 3 and Resin 1. The synergy factor went up to 11%. Comparatively, the Coatings 12-17 prepared from the Comparative Curable Compositions 1-6, as set forth in Table 8 above, did not demonstrate consistent synergistic performance. Instead, as shown with the mixtures of comparative Resins 4/5 of Coatings 13-16, a decrease in performance over the single-resin endpoints is typically observed when the comparative resins are utilized together in analogous amounts relative to the examples set forth above.

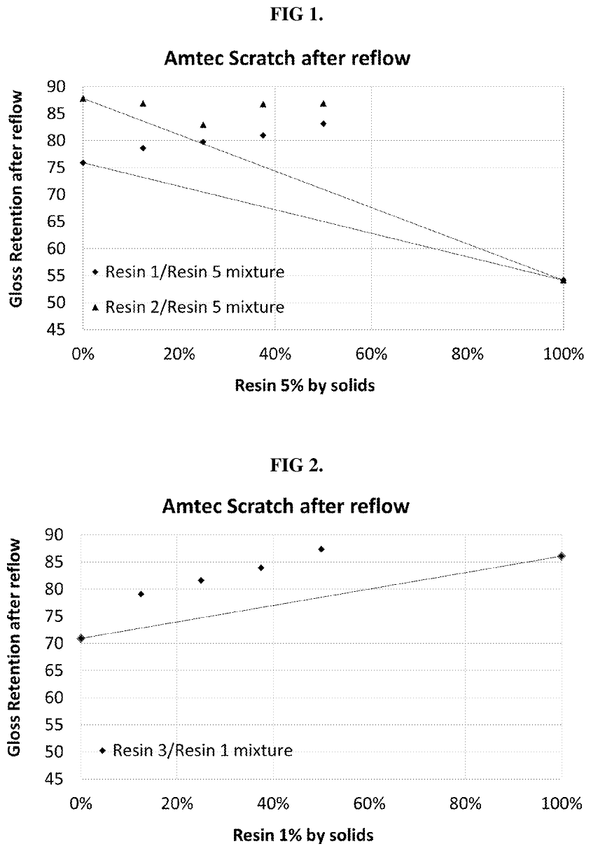

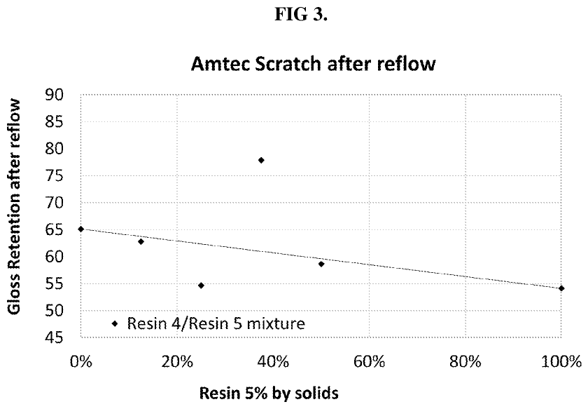

The linear predictions and observed Amtec performance values of these examples are provided in plots shown in FIGS. 1-3, where FIG. 1 provides a plot of the Amtec Test results of the Resin 1/Resin 5 and Resin 2/Resin 5 mixtures (i.e., from Tables 6-7), FIG. 2 provides a plot of the Amtec Test results of the Resin 3/Resin 1 mixtures (i.e., from Table 9), and FIG. 3 provides a plot of the Amtec Test results of the comparative Resin 4/Resin 5 mixtures (i.e., from Table 8). As shown, the asymmetric aspartate resins according to the present embodiments provide a synergistic improvement over the comparative mixtures of conventional aspartate resins. As shown in FIG. 3, the comparative resin mixtures do not exhibit consistent synergistic performance improvements to scratch resistance.

Durability was assed via accelerated exposure/weathering testing using a controlled irradiance Xenon arc (i.e., Xenon Quartz/Boro exposure testing) in accordance with SAE International standard SAE J2527 (version 201709), a performance-based standard for accelerated weathering that uses a xenon arc as a light source to simulate outdoor exposure to sunlight (e.g. UV) on an accelerated basis, which is incorporated by reference herein.

Gloss (20°) was measured before (initial) and after exposure according to the procedure set forth above. Gloss retention was calculated by dividing the gloss value after the exposure by the initial gloss value of a clearcoat. The initial gloss, gloss after exposure(s), and gloss retention for Coating Compositions 1-16 are set forth in Tables 10-12 below.

TABLE 10
Durability & Gloss Retention of Coating Compositions 1-6

| Coating | | C-1 | C-2 | C-3 | C-4 | C-5 | C-6 |
|---|---|---|---|---|---|---|---|
| Curable Comp. | | CC-1 | CC-2 | CC-3 | CC-4 | CC-5 | CCE1 |
| Initial Gloss (20°) | | 79 | 84 | 86 | 84 | 85 | 85 |
| Gloss | 960-hr | 83 | 85 | 86 | 85 | 85 | 85 |
| (20°) after | 1920-hr | 80 | 83 | 85 | 83 | 85 | 85 |
| Exposure | 2880-hr | 78 | 84 | 84 | 83 | 80 | 78 |
| | 3840-hr | 67 | 74 | 66 | 67 | 62 | 15 |
| | 4800-hr | 48 | 62 | 47 | 40 | 39 | 1 |
| Gloss | 960-hr | 105% | 101% | 100% | 101% | 100% | 100% |
| (20°) | 1920-hr | 101% | 99% | 99% | 99% | 100% | 100% |
| Retention | 2880-hr | 99% | 100% | 98% | 99% | 94% | 92% |
| | 3840-hr | 85% | 88% | 77% | 80% | 73% | 18% |
| | 4800-hr | 61% | 74% | 55% | 48% | 46% | 1% |

TABLE 11
Durability & Gloss Retention of Coating Compositions 7-11

| Coating | | C-7 | C-8 | C-9 | C-10 | C-11 |
|---|---|---|---|---|---|---|
| Curable Comp. | | CC-6 | CC-7 | CC-8 | CC-9 | CC-10 |
| Initial Gloss (20°) | | 84 | 85 | 86 | 85 | 84 |
| Gloss | 960-hr | 86 | 86 | 87 | 87 | 87 |
| (20°) after | 1920-hr | 84 | 84 | 83 | 86 | 84 |
| Exposure | 2880-hr | 82 | 82 | 81 | 86 | 82 |
| | 3840-hr | 75 | 70 | 62 | 76 | 65 |
| | 4800-hr | 62 | 67 | 45 | 60 | 51 |
| Gloss | 960-hr | 102% | 101% | 101% | 102% | 104% |
| (20°) | 1920-hr | 100% | 99% | 97% | 101% | 100% |
| Retention | 2880-hr | 98% | 96% | 94% | 101% | 98% |
| | 3840-hr | 89% | 82% | 72% | 89% | 77% |
| | 4800-hr | 74% | 79% | 52% | 71% | 61% |

TABLE 12
Durability & Gloss Retention of Coating Compositions 12-17

| Coating | | C-12 | C-13 | C-14 | C-15 | C-16 |
|---|---|---|---|---|---|---|
| Curable Comp. | | CCE2 | CCE3 | CCE4 | CCE5 | CCE6 |
| Initial Gloss (20°) | | 87 | 88 | 87 | 87 | 85 |
| Gloss | 960-hr | 89 | 88 | 88 | 88 | 88 |
| (20°) after | 1920-hr | 89 | 88 | 88 | 88 | 88 |
| Exposure | 2880-hr | 88 | 89 | 87 | 86 | 85 |
| | 3840-hr | 74 | 82 | 80 | 72 | 71 |
| | 4800-hr | 64 | 71 | 70 | 59 | 53 |
| Gloss | 960-hr | 102% | 100% | 101% | 101% | 104% |
| (20°) | 1920-hr | 102% | 100% | 101% | 101% | 104% |
| Retention | 2880-hr | 101% | 101% | 100% | 99% | 100% |
| | 3840-hr | 85% | 93% | 92% | 83% | 84% |
| | 4800-hr | 74% | 81% | 80% | 68% | 62% |

As shown, the exemplary resin compositions of the present embodiments provide durable coatings, with 4000-hour gloss retentions of at least 50%, such as at least about 55, alternatively at least 60, alternatively at least about 70%. In specific embodiments, the exemplary coating compositions exhibit a 2000-hour gloss retention of at least about 95, alternatively at least about 98, alternatively at least about 99%. In these or other embodiments, the coating composition exhibits a 3000-hour gloss retention of at least about 90, alternatively at least about 95, alternatively at least about 98, alternatively at least about 99%. In these or other embodiments, the coating composition exhibits a 4000-hour gloss retention of at least about 70, alternatively at least about 75, alternatively at least about 80, alternatively at least about 85, alternatively at least about 90%.

It will be appreciated that the endpoints of each range shown in the table above and the plots of FIGS. 1-3 represent single-resin compositions of the present embodiments. As demonstrated by the Amtec Test results, the asymmetric aspartate resins exhibit improved scratch resistance over conventional aspartate resins, represented by those shown at the endpoints of the Resin4/Resin5 comparative mixtures. As shown, the asymmetric aspartate resins of the present embodiments exhibit good or great performance in Amtec performance (i.e., greater than 70%, alternatively greater than 75%). While not quantified in the examples above, it is also reported that the coating compositions comprising Resins 1-3, alone and in the various mixtures of the present embodiments, maintain a good spray viscosity, appearance, productivity, and pot life, such that the improved properties are provided without a penalty to other desirable performance characteristics.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment.

Aspects of the present embodiments are provided below to further illustrate various features thereof.
Aspect 1. provides a polyaspartate composition comprising an asymmetric polyaspartate resin, the asymmetric polyaspartate resin being a reaction product of:
(I) an asymmetric aspartate composition, comprising a reaction product of a mixture of:
   (A) a multi-functional acrylate component comprising an average of at least two acrylate groups per molecule, and being substantially free from mono-functional acrylate compounds,
   (B) at least one dialkyl butenedioate, and
   (C) a multi-functional primary amino compound; and
(II) an isocyanate chain extender.
Aspect 2. provides the polyaspartate composition of Aspect 1, wherein the multi-functional acrylate component (A) comprises: (i) a difunctional acrylic ester; (ii) a trifunctional acrylic ester; or (iii) both (i) and (ii).
Aspect 3. provides the polyaspartate composition of Aspect 1 or 2, wherein the multi-functional acrylate component (A) comprises a trifunctional acrylic ester selected from trimethylolpropane triacrylate (TMPTA), trimethylolpropane ethoxy triacrylate (TMPEOTA), and combinations thereof.
Aspect 4. provides the polyaspartate composition of any one of Aspects 1-3, wherein the multi-functional acrylate component (A) comprises a difunctional acrylic ester selected from linear alkyldiol diacrylates, alternatively from 1,6-hexanediol diacrylate (HDDA), butanediol diacrylate (BDDA), and combinations thereof.
Aspect 5. provides the polyaspartate composition of any one of Aspects 1-4, wherein the multi-functional acrylate component (A) comprises: (i) trimethylolpropane triacrylate (TMPTA); (ii) 1,6-hexanediol diacrylate (HDDA); or (iii) both (i) and (ii).
Aspect 6. provides the polyaspartate composition of any one of Aspects 1-5, wherein the at least one dialkyl butenedioate (B) comprises a dialkyl maleate.
Aspect 7. provides the polyaspartate composition of any one of Aspects 1-6, wherein the at least one dialkyl butenedioate (B) comprises: (i) a dibutyl maleate (DBM); (ii) a dioctyl maleate (DOM); or (iii) both (i) and (ii).
Aspect 8. provides the polyaspartate composition of any one of Aspects 1-6, wherein the at least one dialkyl butenedioate (B) comprises at least two different dialkyl maleates.
Aspect 9. provides the polyaspartate composition of Aspect 8, wherein the at least two different dialkyl maleates comprises a diethyl maleate (DEM), a dibutyl maleate (DBM), a dioctyl maleate (DOM), or a combinations thereof.
Aspect 10. provides the polyaspartate composition of any one of Aspects 1-9, wherein the multi-functional primary amino compound (C) is an organodiamine having two primary amine groups.
Aspect 11. provides the polyaspartate composition of any one of Aspects 1-10, wherein the multi-functional primary amino compound (C) comprises isophoronediamine (IPDA).
Aspect 12. provides the polyaspartate composition of any one of Aspects 1-11, wherein the isocyanate chain extender (II) comprises an alkyl diisocyanate, an aryl diisocyanate, an alkaryl diisocyanate, or a combination thereof.
Aspect 13. provides the polyaspartate composition of any one of Aspects 1-12, wherein the isocyanate chain extender (II) is selected from isophorone diisocyanate (IPDI), 1,5-pentane diisocyanate (PDI), 4,4′-diisocyanato dicyclohexylmethane (HMDI), hexamethylene diisocyanate (HDI), tetramethylxylylene diisocyanate (TMXDI), trimethylhexamethylene diisocyanate (TMDI), toluene diisocyanate (TDI), and combinations thereof.
Aspect 14. provides the polyaspartate composition of any one of Aspects 1-13, wherein the isocyanate chain extender (II) comprises isophorone diisocyanate (IPDI), and wherein in the mixture of (A)-(C) from which the reaction product of the asymmetric aspartate composition (I):
   (i) the multi-functional acrylate component (A) comprises trimethylolpropane triacrylate (TMPTA), trimethylolpropane ethoxy triacrylate (TMPEOTA), 1,6-hexanediol diacrylate (HDDA), butanediol diacrylate (BDDA), or a combination thereof;
   (ii) the at least one dialkyl butenedioate (B) comprises a dibutyl maleate (DBM), a dioctyl maleate (DOM), or a combination thereof;
   (iii) the multi-functional primary amino compound (C) comprises isophoronediamine (IPDA); or
   (iv) any combination of (i)-(iii).
Aspect 15 provides the polyaspartate composition of any one of Aspects 1-14, wherein the mixture of (A)-(C) from which the reaction product of the asymmetric aspartate composition (I) is obtained comprises:
   (i) the multi-functional acrylate component (A) and the at least one dialkyl butenedioate (B) present in a stoichiometric ratio of from about 5:95 to about 50:50 (A):(B), alternatively of from about 5:95 to about 30:70, alternatively of from about 10:90 to about 30:70, alternatively of from about 10:90 to about 25:75 (A):(B);
   (ii) the multi-functional primary amino compound (C) present in a stoichiometric ratio of from about 0.95:1 to about 1.5:1 (C):(A)(B), alternatively of from about 0.95:1 to about 1.4:1, alternatively from about 0.98:1 to about 1.3:1; alternatively from about 0.99:1 to about 1.25:1, alternatively from about 1:1 to about 1.2:1 (C):(A)(B); or
   (iii) both (i) and (ii).
Aspect 16. provides the polyaspartate composition of any one of Aspects 13-15, wherein the asymmetric polyaspartate resin:
   (i) is formed via chain extending the asymmetric aspartate composition (I) with the isocyanate chain extender (II) in a stoichiometric ratio of from about 0.05:1 to about 0.9:1 (II):(C), alternatively from about 0.1:1 to about 0.9:1, alternatively from about 0.1:1 to about 0.75:1, alternatively from about 0.1:1 to about 0.5:1, alternatively from about 0.2:1 to about 0.4:1 (II):(C), the functional equivalent amount of the multi-functional primary amino compound (C) in the mixture of (A)-(C) from which the reaction product of the asymmetric aspartate composition (I) is obtained;
   (ii) is formed via chain extending the asymmetric aspartate composition (I) with the isocyanate chain extender (II) in a stoichiometric ratio of from about 0.05:1 to about 0.9:1, alternatively from about 0.1:1 to about 0.75:1, alternatively from about 0.1:1 to about 0.5:1, alternatively from about 0.2:1 to about 0.4:1 (NCO):(NH), based on the number of free isocyanate groups (NCO) in the isocyanate chain extender (II) and the total number of free amine groups (NH) in the asymmetric aspartate composition (I);
   (iii) is substantially free from isocyanate groups;
   (iv) comprises an amine number of from about 60 to about 80; or
   (v) any combination of (i)-(iv).
Aspect 17. provides a multi-polyaspartate composition, comprising:
(1) a first asymmetric polyaspartate resin, being a reaction product of:
   (I-1) an asymmetric aspartate composition, comprising a reaction product of a mixture of:
      (A1) a multi-functional acrylate component comprising an average of at least two acrylate groups per molecule,
      (B1) at least one dialkyl butenedioate, and
      (C1) a multi-functional primary amino compound, and
   (II-1) an isocyanate chain extender; and
(2) a second asymmetric polyaspartate resin different from the first asymmetric polyaspartate resin (1), and being a reaction product of:
   (I-2) an asymmetric aspartate composition, comprising the reaction product of a mixture of:
      (A2) a multi-functional acrylate component comprising an average of at least two acrylate groups per molecule,
      (B2) at least one dialkyl butenedioate, and
      (C2) a multi-functional primary amino compound, and
   (II-2) an isocyanate chain extender.
Aspect 18. provides the multi-polyaspartate composition of Aspect 17, wherein:
   (i) the multi-functional acrylate component (A1) and the multi-functional acrylate component (A2) each independently comprise difunctional acrylic esters, trifunctional acrylic esters, or combinations thereof;
   (ii) the at least one dialkyl butenedioate (B1) and the at least one dialkyl butenedioate (B2) are each independently selected from dialkyl maleates;
   (iii) the multi-functional primary amino compound (C1) and the multi-functional primary amino compound (C2) are each independently selected from organodiamines having two primary amine groups;
   (iv) the isocyanate chain extender (II-1) and the isocyanate chain extender (II-2) are each independently selected from alkyl diisocyanates, aryl diisocyanates, alkaryl diisocyanates, and combinations thereof; or
   (v) any combination of (i)-(iv).
Aspect 19. provides the multi-polyaspartate composition of Aspect 17 or 18, wherein:
   (i) the multi-functional acrylate component (A1) and the multi-functional acrylate component (A2) are each independently selected from trimethylolpropane triacrylate (TMPTA), trimethylolpropane ethoxy triacrylate (TMPEOTA), 1,6-hexanediol diacrylate (HDDA), butanediol diacrylate (BDDA), and combinations thereof;
   (ii) the at least one dialkyl butenedioate (B1) and the at least one dialkyl butenedioate (B2) are each independently selected from di(C₁-C₁₀)alkyl maleates;
   (iii) at least one of the multi-functional primary amino compound (C1) and the multi-functional primary amino compound (C2) comprises isophoronediamine (IPDA);
   (iv) the isocyanate chain extender (II-1) and the isocyanate chain extender (II-2) are each independently selected from isophorone diisocyanate (IPDI), 1,5-pentane diisocyanate (PDI), 4,4′-diisocyanato dicyclohexylmethane (HMDI), hexamethylene diisocyanate (HDI), tetramethylxylylene diisocyanate (TMXDI), trimethylhexamethylene diisocyanate (TMDI), toluene diisocyanate (TDI), and combinations thereof; or
   (v) any combination of (i)-(iv).
Aspect 20. provides the multi-polyaspartate composition of any one of Aspects 17-19, wherein:
   (i) one of the multi-functional acrylate component (A1) and the multi-functional acrylate component (A2) comprises a trifunctional acrylic ester selected from trimethylolpropane triacrylate (TMPTA), trimethylolpropane ethoxy triacrylate (TMPEOTA), and combinations thereof, and the other of the multi-functional acrylate component (A1) and the multi-functional acrylate component (A2) comprises a difunctional acrylic ester selected from linear alkyldiol diacrylates, alternatively from 1,6-hexanediol diacrylate (HDDA), butanediol diacrylate (BDDA), and combinations thereof;
   (ii) at least one of the at least one dialkyl butenedioate (B1) and the at least one dialkyl butenedioate (B2) comprise a dibutyl maleate (DBM), a dioctyl maleate (DOM), a diethyl maleate (DEM), or a combination thereof, with the proviso that at least one of (B1) and (B2) is free from (DEM);
   (iii) the multi-functional primary amino compound (C1) and the multi-functional primary amino compound (C2) each independently comprises isophoronediamine (IPDA);
   (iv) the isocyanate chain extender (II-1) and the isocyanate chain extender (II-2) each independently comprises isophorone diisocyanate (IPDI); or
   (v) any combination of (i)-(v).
Aspect 21. provides the multi-polyaspartate composition of any one of Aspects 17-20, wherein:
   (i) one of the multi-functional acrylate component (A1) and the multi-functional acrylate component (A2) is trimethylolpropane triacrylate (TMPTA), and the other of the multi-functional acrylate component (A1) and the multi-functional acrylate component (A2) is 1,6-hexanediol diacrylate (HDDA);
   (ii) each of the at least one dialkyl butenedioate (B1) and the at least one dialkyl butenedioate (B2) comprises a dibutyl maleate (DBM), a dioctyl maleate (DOM), or a combination thereof; wherein each of the multi-functional primary amino compound (C1) and the multi-functional primary amino compound (C2) is isophoronediamine (IPDA); and
   (iii) each of the isocyanate chain extender (II-1) and the isocyanate chain extender (II-2) is isophorone diisocyanate (IPDI).
Aspect 22. provides the multi-polyaspartate composition of any one of Aspects 17-21, wherein:
   (i) the mixture of (A1)-(C1) from which the reaction product of the asymmetric aspartate composition (I-1) is obtained comprises the multi-functional acrylate component (A1) and the at least one dialkyl butenedioate (B1) present in a stoichiometric ratio of from about 5:95 to about 50:50 (A1):(B1), alternatively of from about 5:95 to about 30:70, alternatively of from about 10:90 to about 30:70, alternatively of from about 10:90 to about 25:75 (A1):(B1), and the multi-functional primary amino compound (C1) present in a stoichiometric ratio of from about 0.1:1 to about 0.9:1, alternatively from about 0.1:1 to about 0.75:1, alternatively from about 0.1:1 to about 0.5:1, alternatively from about 0.2:1 to about 0.4:1 (C1):(A1)(B1);
   (ii) the mixture of (A2)-(C2) from which the reaction product of the asymmetric aspartate composition (I-2) is obtained comprises the multi-functional acrylate component (A2) and the at least one dialkyl butenedioate (B2) present in a stoichiometric ratio of from about 5:95 to about 50:50 (A2):(B2), alternatively of from about 5:95 to about 30:70, alternatively of from about 10:90 to about 30:70, alternatively of from about 10:90 to about 25:75 (A2):(B2), and the multi-functional primary amino compound (C2) present in a stoichiometric ratio of from about 0.1:1 to about 0.9:1, alternatively from about 0.1:1 to about 0.75:1, alternatively from about 0.1:1 to about 0.5:1, alternatively from about 0.2:1 to about 0.4:1 (C2):(A2)(B2)); or
   (iii) both (i) and (ii).
Aspect 23. provides a coating composition comprising a curable polyaspartate component, wherein the curable polyaspartate component comprises:
   the polyaspartate composition of any one of Aspects 1-16; and/or
   the multi-polyaspartate composition of any one of Aspects 17-22.
Aspect 24. provides the coating composition of Aspect 23, further comprising an isocyanate curing agent.
Aspect 25. provides the coating composition of Aspect 24, wherein the isocyanate curing agent comprises a polyisocyanate selected from oligomeric forms of isophorone diisocyanate (IPDI), 1,5-pentane diisocyanate (PDI), methylene diphenyl diisocyanate (MDI), 4,4′-methylenebis(cyclohexyl isocyanate) (HMDI), hexamethylene diisocyanate (HDI), tetramethylxylylene diisocyanate (TMXDI), trimethylhexamethylene diisocyanate (TMDI), toluene diisocyanate (TDI), polyol-modified derivatives thereof, or combinations thereof.
Aspect 26. provides the coating composition of any one of Aspects 23-25, further comprising an additive component, wherein the additive component comprises a curing catalyst, a UV absorber and/or light-stabilizer, a rheology modifier, an adhesion promotor, a moisture scavenger, a wetting agent, a chain extender, a binder, a levelling and/or flow promotor, or a combination thereof.
Aspect 27. provides the coating composition of any one of Aspects 23-26, wherein the curable polyaspartate component comprises the multi-polyaspartate composition, and wherein:
   (i) the first asymmetric polyaspartate resin (1) and the second asymmetric polyaspartate resin (2) are present in the curable polyaspartate component in a ratio of from about 95:5 to about 5:95 (1):(2), alternatively of from about 90:10 to about 10:90 (1):(2) (wt./wt.);
   (ii) the coating composition comprises the curable polyaspartate component and the polyisocyanate curing agent in a stoichiometric ratio of from about 1.1 to about 1.5 NCO:NH, based on the total number of free isocyanate groups (NCO) in the polyisocyanate curing agent and the total number of free amine groups (NH) in the multi-polyaspartate composition; or
   (iii) both (i) and (ii).
Aspect 28. provides the coating composition of any one of Aspects 23-27 in the form of a two-part curable composition, comprising:
   a first part comprising the polyaspartate component, and
   a second part comprising the curing agent.
Aspect 29. provides the coating composition of Aspect 28, wherein in the two-part curable composition:
   (i) the first part further comprises a UV absorber and/or light-stabilizer, a rheology modifier, a wetting agent, a levelling and/or flow promotor, or a combination thereof;
   (ii) the second part further comprises a curing catalyst, an adhesion promotor, a moisture scavenger, a chain extender, a binder, or a combination thereof; or
   (iii) both (i) and (ii).
Aspect 30. provides the coating composition of any one of Aspects 23-29, wherein the curable polyaspartate component comprises the multi-polyaspartate composition, wherein the coating composition further comprises a polyisocyanate curing agent, and wherein the coating composition prepares a coating that exhibits a synergistic Amtec performance higher than an expected Amtec performance of a substantially similar theoretical coating calculated from the linear relationship of coating compositions each comprising but one polyaspartate resin of the multi-polyaspartate composition.
Aspect 31. provides the coating composition of Aspect 30, wherein the synergistic Amtec performance exhibited by the coating is at least about 3% higher than the expected Amtec performance of the substantially similar theoretical coating.
Aspect 32. provides the method of preparing a coated article, comprising:
   a) coating at least a portion of a substrate with a coating composition; and
   b) curing the coating composition to give a coating on the substrate, thereby preparing a coated article;
wherein the coating composition is the coating composition of any one of Aspects 23-31.

Aspect 33. provides a coated article prepared by the method of Aspect 32.

It is to be understood that various changes may be made in the function and arrangement of elements described in the exemplary embodiments above, without departing from the scope as set forth in the appended claims. Moreover, all combinations of the aforementioned components, compositions, method steps, formulation steps, etc. are hereby expressly contemplated for use herein in various non-limiting embodiments even if such combinations are not expressly described in the same or similar paragraphs.

With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the ranges and subranges enumerated herein sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. An individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims. Lastly, it will be understood that the term “about” with regard to any of the particular numbers and ranges described herein is used to designate values within standard error, equivalent function, efficacy, final loading, etc., as understood by those of skill in the art with relevant conventional techniques and processes for formulation and/or utilizing compounds and compositions such as those described herein. As such, the term “about” may designate a value within 10, alternatively within 5, alternatively within 1, alternatively within 0.5, alternatively within 0.1, % of the enumerated value or range.

While the present disclosure has been described with respect to particular embodiments thereof, it is apparent that numerous other forms and modifications will be obvious to those skilled in the art. The appended claims and this disclosure generally should be construed to cover all such obvious forms and modifications, which are within the true scope of the present disclosure.

1. A polyaspartate composition comprising an asymmetric polyaspartate resin, the asymmetric polyaspartate resin being a reaction product of:
(I) an asymmetric aspartate composition, comprising a reaction product of a mixture of:
(A) a multi-functional acrylate component comprising an average of at least two acrylate groups per molecule, and being substantially free from mono-functional acrylate compounds,
(B) at least one dialkyl butenedioate, and
(C) a multi-functional primary amino compound; and
(II) an isocyanate chain extender.

2. The polyaspartate composition of claim 1, wherein:
(i) the multi-functional acrylate component (A) comprises a difunctional acrylic ester and/or a trifunctional acrylic ester;
(ii) the at least one dialkyl butenedioate (B) comprises a dialkyl maleate;
(iii) the multi-functional primary amino compound (C) is an organodiamine having two primary amine groups; or
(iv) any combination of (i)-(iii).

3. The polyaspartate composition of claim 1, wherein:
(i) the multi-functional acrylate component (A) comprises a trifunctional acrylic ester selected from trimethylolpropane triacrylate (TMPTA), trimethylolpropane ethoxy triacrylate (TMPEOTA), and combinations thereof;
(ii) the multi-functional acrylate component (A) comprises a difunctional acrylic ester selected from linear alkyldiol diacrylates, alternatively from 1,6-hexanediol diacrylate (HDDA), butanediol diacrylate (BDDA), and combinations thereof;
(iii) the at least one dialkyl butenedioate (B) comprises at least two different dialkyl maleates, optionally each selected from diethyl maleate (DEM), dibutyl maleate (DBM), dioctyl maleate (DOM), and combinations thereof;
(iv) the multi-functional primary amino compound (C) comprises isophoronediamine (IPDA);
(v) the isocyanate chain extender (II) comprises an alkyl diisocyanate, an aryl diisocyanate, an alkaryl diisocyanate, or a combination thereof; or
(vi) any combination of (i)-(v).

4. The polyaspartate composition of claim 1, wherein:
(i) the multi-functional acrylate component (A) comprises trimethylolpropane triacrylate (TMPTA) and/or 1,6-hexanediol diacrylate (HDDA);
(ii) the at least one dialkyl butenedioate (B) comprises a dibutyl maleate (DBM) and/or a dioctyl maleate (DOM);
(iii) the isocyanate chain extender (II) is selected from isophorone diisocyanate (IPDI), 1,5-pentane diisocyanate (PDI), 4,4′-diisocyanato dicyclohexylmethane (HMDI), hexamethylene diisocyanate (HDI), tetramethylxylylene diisocyanate (TMXDI), trimethylhexamethylene diisocyanate (TMDI), toluene diisocyanate (TDI), and combinations thereof; or
(iv) any combination of (i)-(iii).

5. The polyaspartate composition of claim 1, wherein the isocyanate chain extender (II) comprises isophorone diisocyanate (IPDI), and wherein in the mixture of (A)-(C) from which the reaction product of the asymmetric aspartate composition (I) is obtained:
(i) the multi-functional acrylate component (A) comprises trimethylolpropane triacrylate (TMPTA), trimethylolpropane ethoxy triacrylate (TMPEOTA), 1,6-hexanediol diacrylate (HDDA), butanediol diacrylate (BDDA), or a combination thereof;
(ii) the at least one dialkyl butenedioate (B) comprises a dibutyl maleate (DBM), a dioctyl maleate (DOM), or a combination thereof;
(iii) the multi-functional primary amino compound (C) comprises isophoronediamine (IPDA); or
(iv) any combination of (i)-(iii).

6. The polyaspartate composition of claim 1, wherein the mixture of (A)-(C) from which the reaction product of the asymmetric aspartate composition (I) is obtained comprises:
(i) the multi-functional acrylate component (A) and the at least one dialkyl butenedioate (B) present in a stoichiometric ratio of from about 5:95 to about 50:50 (A):(B);
(ii) the multi-functional primary amino compound (C) present in a stoichiometric ratio of from about 0.95:1 to about 1.5:1 (C):(A)(B); or
(iii) both (i) and (ii).

7. The polyaspartate composition of claim 1, wherein the asymmetric polyaspartate resin:
(i) is formed via chain extending the asymmetric aspartate composition (I) with the isocyanate chain extender (II) in a stoichiometric ratio of from about 0.05:1 to about 0.9:1 (II):(C), the functional equivalent amount of the multi-functional primary amino compound (C) in the mixture of (A)-(C) from which the reaction product of the asymmetric aspartate composition (I) is obtained;
(ii) is formed via chain extending the asymmetric aspartate composition (I) with the isocyanate chain extender (II) in a stoichiometric ratio of from about 0.05:1 to about 0.9:1 (NCO):(NH), based on the number of free isocyanate groups (NCO) in the isocyanate chain extender (II) and the total number of free amine groups (NH) in the asymmetric aspartate composition (I);
(iii) is substantially free from isocyanate groups;
(iv) comprises an amine number of from about 60 to about 80; or
(v) any combination of (i)-(iv).

8. A multi-polyaspartate composition, comprising:
(1) a first asymmetric polyaspartate resin, being a reaction product of:
(I-1) an asymmetric aspartate composition, comprising a reaction product of a mixture of:
(A1) a multi-functional acrylate component comprising an average of at least two acrylate groups per molecule,
(B1) at least one dialkyl butenedioate, and
(C1) a multi-functional primary amino compound, and
(II-1) an isocyanate chain extender; and
(2) a second asymmetric polyaspartate resin different from the first asymmetric polyaspartate resin (1), and being a reaction product of:
(I-2) an asymmetric aspartate composition, comprising the reaction product of a mixture of:
(A2) a multi-functional acrylate component comprising an average of at least two acrylate groups per molecule,
(B2) at least one dialkyl butenedioate, and
(C2) a multi-functional primary amino compound, and
(II-2) an isocyanate chain extender.

9. The multi-polyaspartate composition of claim 8, wherein:
(i) the multi-functional acrylate component (A1) and the multi-functional acrylate component (A2) each independently comprise difunctional acrylic esters, trifunctional acrylic esters, or combinations thereof;
(ii) the at least one dialkyl butenedioate (B1) and the at least one dialkyl butenedioate (B2) are each independently selected from dialkyl maleates;
(iii) the multi-functional primary amino compound (C1) and the multi-functional primary amino compound (C2) are each independently selected from organodiamines having two primary amine groups;
(iv) the isocyanate chain extender (II-1) and the isocyanate chain extender (II-2) are each independently selected from alkyl diisocyanates, aryl diisocyanates, alkaryl diisocyanates, and combinations thereof; or
(v) any combination of (i)-(iv).

10. The multi-polyaspartate composition of claim 8, wherein:
(i) the multi-functional acrylate component (A1) and the multi-functional acrylate component (A2) are each independently selected from trimethylolpropane triacrylate (TMPTA), trimethylolpropane ethoxy triacrylate (TMPEOTA), 1,6-hexanediol diacrylate (HDDA), butanediol diacrylate (BDDA), and combinations thereof;
(ii) the at least one dialkyl butenedioate (B1) and the at least one dialkyl butenedioate (B2) are each independently selected from di(C1-C10)alkyl maleates;
(iii) at least one of the multi-functional primary amino compound (C1) and the multi-functional primary amino compound (C2) comprises isophoronediamine (IPDA);
(iv) the isocyanate chain extender (II-1) and the isocyanate chain extender (II-2) are each independently selected from isophorone diisocyanate (IPDI), 1,5-pentane diisocyanate (PDI), 4,4′-diisocyanato dicyclohexylmethane (HMDI), hexamethylene diisocyanate (HDI), tetramethylxylylene diisocyanate (TMXDI), trimethylhexamethylene diisocyanate (TMDI), toluene diisocyanate (TDI), and combinations thereof; or
(v) any combination of (i)-(iv).

11. The multi-polyaspartate composition of claim 8, wherein:
(i) one of the multi-functional acrylate component (A1) and the multi-functional acrylate component (A2) comprises a trifunctional acrylic ester selected from trimethylolpropane triacrylate (TMPTA), trimethylolpropane ethoxy triacrylate (TMPEOTA), and combinations thereof, and the other of the multi-functional acrylate component (A1) and the multi-functional acrylate component (A2) comprises a difunctional acrylic ester selected from linear alkyldiol diacrylates, alternatively from 1,6-hexanediol diacrylate (HDDA), butanediol diacrylate (BDDA), and combinations thereof;
(ii) at least one of the at least one dialkyl butenedioate (B1) and the at least one dialkyl butenedioate (B2) comprise a dibutyl maleate (DBM), a dioctyl maleate (DOM), a diethyl maleate (DEM), or a combination thereof, with the proviso that at least one of (B1) and (B2) is free from (DEM);
(iii) the multi-functional primary amino compound (C1) and the multi-functional primary amino compound (C2) each independently comprises isophoronediamine (IPDA);
(iv) the isocyanate chain extender (II-1) and the isocyanate chain extender (II-2) each independently comprises isophorone diisocyanate (IPDI); or
(v) any combination of (i)-(v).

12. The multi-polyaspartate composition of claim 8, wherein:
(i) one of the multi-functional acrylate component (A1) and the multi-functional acrylate component (A2) is trimethylolpropane triacrylate (TMPTA), and the other of the multi-functional acrylate component (A1) and the multi-functional acrylate component (A2) is 1,6-hexanediol diacrylate (HDDA);
(ii) each of the at least one dialkyl butenedioate (B1) and the at least one dialkyl butenedioate (B2) comprises a dibutyl maleate (DBM), a dioctyl maleate (DOM), or a combination thereof; wherein each of the multi-functional primary amino compound (C1) and the multi-functional primary amino compound (C2) is isophoronediamine (IPDA); and
(iii) each of the isocyanate chain extender (II-1) and the isocyanate chain extender (II-2) is isophorone diisocyanate (IPDI).

13. The multi-polyaspartate composition of claim 8, wherein:
(i) the mixture of (A1)-(C1) from which the reaction product of the asymmetric aspartate composition (I-1) is obtained comprises the multi-functional acrylate component (A1) and the at least one dialkyl butenedioate (B1) present in a stoichiometric ratio of from about 5:95 to about 50:50 (A1):(B1), and the multi-functional primary amino compound (C1) present in a stoichiometric ratio of from about 0.1:1 to about 0.9:1 (C1):(A1)(B1);
(ii) the mixture of (A2)-(C2) from which the reaction product of the asymmetric aspartate composition (I-2) is obtained comprises the multi-functional acrylate component (A2) and the at least one dialkyl butenedioate (B2) present in a stoichiometric ratio of from about 5:95 to about 50:50 (A2):(B2), and the multi-functional primary amino compound (C2) present in a stoichiometric ratio of from about 0.1:1 to about 0.9:1 (C2):(A2)(B2)); or
(iii) both (i) and (ii).

14. A coating composition comprising:
a curable polyaspartate component, wherein the curable polyaspartate component comprises the polyaspartate composition of claim 1;
an isocyanate curing agent selected from oligomeric forms of isophorone diisocyanate (IPDI), 1,5-pentane diisocyanate (PDI), methylene diphenyl diisocyanate (MDI), 4,4′-methylenebis(cyclohexyl isocyanate) (HMDI), hexamethylene diisocyanate (HDI), tetramethylxylylene diisocyanate (TMXDI), trimethylhexamethylene diisocyanate (TMDI), toluene diisocyanate (TDI), polyol-modified derivatives thereof, and combinations thereof; and, optionally
an additive component optionally comprising a curing catalyst, a UV absorber and/or light-stabilizer, a rheology modifier, an adhesion promotor, a moisture scavenger, a wetting agent, a chain extender, a binder, a levelling and/or flow promotor, or a combination thereof.

15. A coating composition comprising:
a curable polyaspartate component, wherein the curable polyaspartate component comprises the multi-polyaspartate composition of claim 8;
an isocyanate curing agent selected from oligomeric forms of isophorone diisocyanate (IPDI), 1,5-pentane diisocyanate (PDI), methylene diphenyl diisocyanate (MDI), 4,4′-methylenebis(cyclohexyl isocyanate) (HMDI), hexamethylene diisocyanate (HDI), tetramethylxylylene diisocyanate (TMXDI), trimethylhexamethylene diisocyanate (TMDI), toluene diisocyanate (TDI), polyol-modified derivatives thereof, and combinations thereof; and, optionally
an additive component optionally comprising a curing catalyst, a UV absorber and/or light-stabilizer, a rheology modifier, an adhesion promotor, a moisture scavenger, a wetting agent, a chain extender, a binder, a levelling and/or flow promotor, or a combination thereof;
wherein:
(i) the first asymmetric polyaspartate resin (1) and the second asymmetric polyaspartate resin (2) are present in the curable polyaspartate component in a ratio of from about 95:5 to about 5:95 (1):(2) (wt./wt.);
(ii) the coating composition comprises the curable polyaspartate component and the polyisocyanate curing agent in a stoichiometric ratio of from about 1.1 to about 1.5 NCO:NH, based on the total number of free isocyanate groups (NCO) in the polyisocyanate curing agent and the total number of free amine groups (NH) in the multi-polyaspartate composition; or
(iii) both (i) and (ii).

16. A two-part curable composition, comprising:
a first part comprising a curable polyaspartate component, comprising the polyaspartate composition of claim 1; and
a second part comprising a curing agent;
optionally wherein:
(i) the first part further comprises a UV absorber and/or light-stabilizer, a rheology modifier, a wetting agent, a levelling and/or flow promotor, or a combination thereof;
(ii) the second part further comprises a curing catalyst, an adhesion promotor, a moisture scavenger, a chain extender, a binder, or a combination thereof; or
(iii) both (i) and (ii).

17. The coating composition of claim 16, wherein the curable composition prepares a coating that exhibits a synergistic Amtec performance higher than an expected Amtec performance of a substantially similar theoretical coating calculated from the linear relationship of coating compositions each comprising but one polyaspartate resin of the multi-polyaspartate composition, optionally wherein the synergistic Amtec performance exhibited by the coating is at least about 3% higher than the expected Amtec performance of the substantially similar theoretical coating.

18. A two-part curable composition, comprising:
a first part comprising a curable polyaspartate component, comprising the multi-polyaspartate composition of claim 8; and
a second part comprising the curing agent;
optionally wherein:
(i) the first part further comprises a UV absorber and/or light-stabilizer, a rheology modifier, a wetting agent, a levelling and/or flow promotor, or a combination thereof;
(ii) the second part further comprises a curing catalyst, an adhesion promotor, a moisture scavenger, a chain extender, a binder, or a combination thereof; or
(iii) both (i) and (ii).

19. The coating composition of claim 18, wherein the curable composition prepares a coating that exhibits a synergistic Amtec performance higher than an expected Amtec performance of a substantially similar theoretical coating calculated from the linear relationship of coating compositions each comprising but one polyaspartate resin of the multi-polyaspartate composition, optionally wherein the synergistic Amtec performance exhibited by the coating is at least about 3% higher than the expected Amtec performance of the substantially similar theoretical coating.

20. A coated article comprising a coating prepared from the coating composition of claim 14.
